(19) United States
(12) Patent Application Publication
(10) Pub. No.: US 2025/0343695 A1
(43) Pub. Date: Nov. 6, 2025

(54) PERSONAL IOT NETWORK (PIN) PRIMITIVE CREDENTIAL CONFIGURATION METHOD AND APPARATUS, COMMUNICATION DEVICE, AND STORAGE MEDIUM

(71) Applicant: Beijing Xiaomi Mobile Software Co., Ltd., Beijing (CN)

(72) Inventors: Haoran LIANG, Beijing (CN); Wei LU, Beijing (CN)

(73) Assignee: Beijing Xiaomi Mobile Software Co., Ltd., Beijing (CN)

(21) Appl. No.: 18/871,007

(22) PCT Filed: Jun. 2, 2022
(86) PCT No.: PCT/CN2022/096962

§ 371 Date: Dec. 2, 2024

(51) Int. Cl. H04L 9/32; H04W 12/086

(52) U.S. Cl. CPC H04L 9/3226; H04W 12/086

(57) ABSTRACT

A method for personal IoT network (PIN) element credential provisioning, is performed by a PIN element gateway, and includes: receiving first information sent by a PIN element, wherein the first information is used to request for provisioning a credential to the PIN element; and sending authentication result information to the PIN element in response to the PIN element gateway performing an operation of credential provisioning.

### CROSS REFERENCE TO RELATED APPLICATIONS

The present application is a U.S. National Stage of International Application No. PCT/CN2022/096962, filed on Jun. 2, 2022, all contents of which are incorporated herein by reference in their entireties for all purposes.

### TECHNICAL FIELD

The present disclosure relates to the technology of identity authentication in the personal IoT (Internet of Things) network, and in particular, to a method for personal IoT network (PIN) element credential provisioning, an apparatus, a communication device, and a storage medium.

### BACKGROUND

The personal IoT network (PIN) is composed of PIN elements that perform communication by using PIN direct connections or direct network connections, and performs local management by using PIN elements with management capabilities. Examples of PIN include wearable device networks and smart home/smart office devices. Through PIN elements with gateway capability, PIN elements may access 5G network services and may perform communication with PIN elements that are not within the range, to use the PIN direct connections. The PIN includes at least one PIN element with gateway capability (PEGC) and at least one PIN element with management capability (PEMC). The PEGC and the PEMC may also be terminals that are directly connected to the 5G system. The PEMC can access the 5G system through the PEGC.

### SUMMARY

According to a first aspect of the present disclosure, there is provided a method for personal IoT network (PIN) element credential provisioning, where the method is performed by a PIN element gateway, and the method includes:
receiving first information sent by a PIN element, where the first information is used to request for provisioning a credential to the PIN element; and
sending authentication result information to the PIN element in response to the PIN element gateway performing an operation of credential provisioning.

According to a second aspect of the present disclosure, there is provided a method for personal IoT network (PIN) element credential provisioning, where the method is performed by a PIN element, and the method includes:
sending first information to a PIN element gateway, where the first information is used to request for provisioning a credential to the PIN element; and
receiving authentication result information sent by the PIN element gateway.

According to a third aspect of the present disclosure, there is provided a method for personal IoT network (PIN) element credential provisioning, and the method includes:
sending, by a PIN element, first information to a PIN element gateway, wherein the first information is used to request for provisioning a credential to the PIN element;
sending, by the PIN element gateway, sixth information to a first network function;
sending, by the first network function, second information to a second network function, wherein the second information is used to trigger authentication of the PIN element;
sending, by the second network function, third information to a third network function, wherein the third information is used to request for obtaining auxiliary information of a credential;
sending, by the third network function, the auxiliary information to the second network function;
sending, by the second network function, fourth information to a fourth network function, wherein the fourth information is used to request for performing authentication of the PIN element;
performing, by the fourth network function, mutual authentication between the PIN element and a third-party authentication authorization accounting (AAA) server;
receiving, by the fourth network function, authentication result information sent by the third-party AAA server, and sending the authentication result information to the second network function;
in response to the authentication result information indicating successful authentication, sending, by the second network function, notification information to an application function; and
provisioning, by the application function, a credential to the PIN element based on the notification information.

According to a fourth aspect of the present disclosure, there is provided a communication device, including:
a processor; and
a memory, configured to store an executable instruction by the processor;
where the processor is configured to, when running the executable instruction, implement the method according to any embodiment of the present disclosure.

According to a fifth aspect of the embodiments of the present disclosure, there is provided a computer storage medium, where a computer executable program is stored in the computer storage medium, and when the executable program is executed by a processor, the method according to any embodiment of the present disclosure is implemented.

### BRIEF DESCRIPTION OF THE DRAWINGS

The accompanying drawings, which are incorporated in and constitute a part of the description, illustrate embodiments consistent with the present disclosure and, together with the description, serve to explain the principles of embodiments of the present disclosure.

FIG. 1 is a schematic structural diagram of a wireless communication system shown according to some embodiments of the present disclosure;

FIG. 2 is a schematic flowchart of a method for PIN element credential provisioning shown according to some embodiments of the present disclosure;

FIG. 3 is a schematic flowchart of a method for PIN element credential provisioning shown according to some embodiments of the present disclosure;

FIG. 4 is a schematic flowchart of a method for PIN element credential provisioning shown according to some embodiments of the present disclosure;

FIG. 5 is a schematic flowchart of a method for PIN element credential provisioning shown according to some embodiments of the present disclosure;

FIG. 6 is a schematic flowchart of a method for PIN element credential provisioning shown according to some embodiments of the present disclosure;

FIG. 7 is a schematic flowchart of a method for PIN element credential provisioning shown according to some embodiments of the present disclosure;

FIG. 8 is a schematic flowchart of a method for PIN element credential provisioning shown according to some embodiments of the present disclosure;

FIG. 9 is a schematic flowchart of a method for PIN element credential provisioning shown according to some embodiments of the present disclosure;

FIG. 10 is a schematic flowchart of a method for PIN element credential provisioning shown according to some embodiments of the present disclosure;

FIG. 11 is a schematic flowchart of a method for PIN element credential provisioning shown according to some embodiments of the present disclosure;

FIG. 12 is a schematic flowchart of a method for PIN element credential provisioning shown according to some embodiments of the present disclosure;

FIG. 13 is a schematic flowchart of a method for PIN element credential provisioning shown according to some embodiments of the present disclosure;

FIG. 14 is a schematic flowchart of a method for PIN element credential provisioning shown according to some embodiments of the present disclosure;

FIG. 15 is a schematic flowchart of a method for PIN element credential provisioning shown according to some embodiments of the present disclosure;

FIG. 16 is a schematic flowchart of a method for PIN element credential provisioning shown according to some embodiments of the present disclosure;

FIG. 17 is a schematic flowchart of a method for PIN element credential provisioning shown according to some embodiments of the present disclosure;

FIG. 18 is a schematic flowchart of a method for PIN element credential provisioning shown according to some embodiments of the present disclosure;

FIG. 19 is a schematic flowchart of a method for PIN element credential provisioning shown according to some embodiments of the present disclosure;

FIG. 20 is a schematic flowchart of a method for PIN element credential provisioning shown according to some embodiments of the present disclosure;

FIG. 21 is a schematic flowchart of a method for PIN element credential provisioning shown according to some embodiments of the present disclosure;

FIG. 22 is a schematic flowchart of a method for PIN element credential provisioning shown according to some embodiments of the present disclosure;

FIG. 23 is a schematic flowchart of a method for PIN element credential provisioning shown according to some embodiments of the present disclosure;

FIG. 24 is a schematic flowchart of a method for PIN element credential provisioning shown according to some embodiments of the present disclosure;

FIG. 25 is a schematic flowchart of a method for PIN element credential provisioning shown according to some embodiments of the present disclosure;

FIG. 26 is a schematic diagram of an apparatus for PIN element authentication shown according to some embodiments of the present disclosure;

FIG. 27 is a schematic diagram of an apparatus for PIN element authentication shown according to some embodiments of the present disclosure;

FIG. 28 is a schematic diagram of an apparatus for PIN element authentication shown according to some embodiments of the present disclosure;

FIG. 29 is a schematic diagram of an apparatus for PIN element authentication shown according to some embodiments of the present disclosure;

FIG. 30 is a schematic diagram of an apparatus for PIN element authentication shown according to some embodiments of the present disclosure;

FIG. 31 is a schematic diagram of an apparatus for PIN element authentication shown according to some embodiments of the present disclosure;

FIG. 32 is a schematic diagram of an apparatus for PIN element authentication shown according to some embodiments of the present disclosure; and

FIG. 33 is a schematic structural diagram of a terminal shown according to some embodiments of the present disclosure.

### DETAILED DESCRIPTION

Example embodiments are described in detail here, examples of which are illustrated in the accompanying drawings. The following description refers to the accompanying drawings in which the same numbers in different drawings represent the same or similar elements unless otherwise represented. The implementations described in the following example embodiments do not represent all implementations consistent with the embodiments of the present disclosure. By contrast, they are merely examples of apparatuses and methods consistent with some aspects of the embodiments of the present disclosure as detailed in the appended claims.

Terms used in the embodiments of the present disclosure are merely for the purpose of describing particular embodiments, and are not intended to limit the embodiments of the present disclosure. The singular forms “a”, “said” and “the” used in the embodiments of the present disclosure and the appended claims are also intended to include plural forms, unless the context clearly indicates other meanings. It should also be understood that the term “and/or” as used here refers to and includes any or all possible combinations of one or more associated listed items.

It should be understood that although the terms of “first”, “second”, “third”, or the like, may be used in the embodiments of the present disclosure to describe various information, these information should not be limited to these terms. These terms are only used to distinguish the same type of information from each other. For example, without departing from the scope of the embodiments of the present disclosure, the first information may also be referred to as second information, and similarly, the second information may also be referred to as first information. Depending on the context, the word “if” as used here may be interpreted as “at . . . the time that” or “when . . . ” or “in response to determining . . . ”.

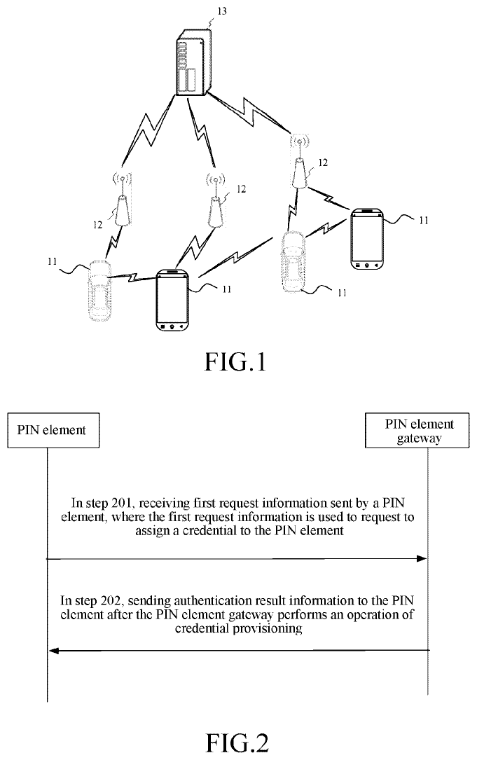

Referring to FIG. 1, it shows a schematic structural diagram of a wireless communication system provided according to some embodiments of the present disclosure. As shown in FIG. 1, the wireless communication system is a communication system based on cellular mobile communication technology, and the wireless communication system may include a plurality of terminals 11 and a plurality of base stations 12.

In some embodiments, the terminal 11 may refer to a device that provides voice and/or data connectivity to a user. The terminal 11 may communicate with one or more core networks via a radio access network (RAN). The terminal 11 may be an IoT terminal, such as a sensor device, a mobile phone (or referred to as a “cellular” phone), and a computer having an IoT terminal; for example, it may be a fixed, portable, pocket-sized, hand-held, computer-built-in, or vehicle-mounted apparatus, such as, a station (STA), a subscriber unit, a subscriber station, a mobile station, a mobile, a remote station, an access point, a remote terminal, an access terminal, a user terminal, a user agent, a user device, or user equipment (UE). Alternatively, the terminal 11 may also be a device of an unmanned aerial vehicle. Alternatively, the terminal 11 may be a vehicle-mounted device; for example, it may be a trip computer having a wireless communication function, or a wireless communication device externally connected to a trip computer. Alternatively, the terminal 11 may be an infrastructure; for example, it may be a street lamp, a signal lamp, another infrastructure, or the like, with a wireless communication function.

The base station 12 may be a network side device in a wireless communication system. In some embodiments, the wireless communication system may be a 4th generation mobile communication (4G) system, which is also referred to as a long term evolution (LTE) system. Alternatively, the wireless communication system may be a 5G system, which is also referred to as a new radio (NR) system or a 5G NR system. Alternatively, the wireless communication system may be any generation system. In some embodiments, the access network in the 5G system may be referred to as a new generation-radio access network (NG-RAN). Alternatively, the wireless communication system may be an MTC system.

In some embodiments, the base station 12 may be an evolved base station (eNB) used in a 4G system. Alternatively, the base station 12 may also be a base station (gNB) adopting a centralized distributed architecture in a 5G system. When the base station 12 adopts a centralized distributed architecture, it usually includes a central unit (CU) and at least two distributed units (DU). A protocol stack for the packet data convergence protocol (PDCP) layer, the radio link control (RLC) layer, and the media access control (MAC) layer is provided in the centralized unit; and a protocol stack for the physical (PHY) layer is provided in the distributed unit. The specific implementation of the base station 12 is not limited in the embodiments of the present disclosure.

A wireless connection may be established between the base station 12 and the terminal 11 through a wireless air interface. In different embodiments, the wireless air interface is a wireless air interface based on the 4th generation mobile communication network technology (4G) standard. Alternatively, the wireless air interface is a wireless air interface based on the 5th generation mobile communication network technology (5G) standard; for example, the wireless air interface is a new radio. Alternatively, the wireless air interface may also be a wireless air interface based on a next-generation of 5G mobile communication network technology standard.

In some embodiments, an end-to-end (E2E) connection may also be established between the terminals 11, for example, in scenarios of vehicle to vehicle (V2V) communication, vehicle to infrastructure (V2I) communication, and vehicle to pedestrian (V2P) communication in vehicle to everything (V2X) communication, etc.

In some embodiments, the wireless communication system may further include a network management device 13.

The execution body involved in the embodiments of the present disclosure includes, but is not limited to, user equipment (UE) in a cellular mobile communication system, a base station in a cellular mobile communication system, or the like.

In order to better understand the embodiments of the present disclosure, the wireless communication scenario of the PIN network is described below.

In some application scenarios, some types of IoT devices may be placed around a human body (i.e., wearable devices, such as cameras, headphones, watches, headphones, health monitors, etc.), dispersed at home (e.g., smart lights, pick-up heads, thermostats, door sensors, voice assistants, speakers, refrigerators, washing machines, mowers, robots, etc.), or provided in offices or factories of small businesses, (e.g., printers, meters, sensors, etc.).

In some embodiments, some IoT devices (e.g., earplugs) have very specific requirements in size, and some IoT devices (e.g., glasses) have very specific requirements in weight. In addition, some IoT devices have very specific requirements in multiple fields (i.e., size, weight, and power consumption). Based on the sharp increase in the number of IoT devices, users create (e.g., plan and/or change the topology of) networks using all of these IoT devices mainly at home, in the office, in the factory, and/or around the human body.

In some embodiments, the network created by the user is composed of devices in the personal IoT network (PIN). The PIN includes three types of devices (PIN elements): a PIN element with gateway capability (PEGC), a PIN element with management capability (PEMC), and a device without gateway capability and management capability. The PEGC and the PEMC are also user equipment (UE) that can be directly connected to the 5G system. The PEMC can also access the 5G system through the PEGC.

In an application scenario, the PIN element cannot directly access the 5G system, and the 5G system needs to identify the PIN element to enhance management. To satisfy the requirements, the 5G system needs to provision an operator credential to the PIN element. By using the operator credential, the 5G system may verify and identify the PIN element behind the PEGC. However, for PIN elements preconfigured with default credentials by using a third-party authentication authorization accounting (AAA) server, there is no mechanism for the 5G system to provision operator credentials to them. This prevents the 5G system from managing and identifying PIN elements behind the PEGC. In a PIN scenario using a third-party authentication authorization accounting (AAA) server, operator credentials may not be securely provisioned to the PIN element.

FIG. 2 is a schematic flowchart of a method for personal IoT network (PIN) element credential provisioning shown according to some embodiments of the present disclosure. As shown in FIG. 2, the method for personal IoT network (PIN) element credential provisioning according to embodiments of the present disclosure is applied to a PIN element gateway, and the method for personal IoT network (PIN) element credential provisioning includes the following processing steps.

In step 201, first request information sent by a PIN element is received, where the first request information is used to request for assigning a credential to the PIN element.

In step 202, authentication result information is sent to the PIN element after the PIN element gateway performs an operation of credential provisioning.

Here, the PIN element and/or the PIN element gateway involved in the present disclosure may be a terminal, and the terminal may be, but is not limited to, a mobile phone, a wearable device, a vehicle-mounted terminal, a road side unit (RSU), a smart home terminal, an industrial sensing device, and/or a medical device, etc. In some embodiments, the PIN element and/or the PIN element gateway may be a Redcap terminal or a new radio (NR) terminal in a predetermined version (e.g., NR terminal in R17).

Here, the network created by the user may be composed of devices in the IoT network (PIN). The PIN may include three types of devices: a PIN element with gateway capability (PEGC), a PIN element with management capability (PEMC), and a device without gateway capability and management capability. In the present disclosure, the PIN element may refer to a device without gateway capability and management capability. Certainly, in a specific scenario, when the PEGC and/or the PEMC need to be authenticated, the PIN element may also be a PEGC and/or a PEMC, which is not limited here. It should be noted that, if the PIN element gateway is a PEGC, and the PIN element is also a PEGC, the PIN element gateway and the PIN element are different PEGCs. If the PIN element gateway is a PEMC, and the PIN element is also a PEMC, the PIN element gateway and the PIN element are different PEMCs. The description of this part is applicable to other embodiments of the present disclosure, and will not be described in detail subsequently.

Here, the PIN element gateway itself may be a PIN element. It should be noted that, if the PIN element gateway is a PEMC, and the PIN element is also PEMC, the PIN element gateway and the PIN element are different PEMCs.

The network functions involved in the present disclosure may be various types of network functions, such as, network functions of a 5th generation mobile communication (5G) network, or other evolved network functions.

In the embodiments of the present disclosure, the terminal may be used as an access gateway of a PIN element; that is, the terminal may be enabled as a private IoT gateway, such as a PEGC. The PIN element may access the 5G mobile network through the terminal. The PIN element itself may also be a terminal.

A terminal used as a PEGC may negotiate how to establish a secure non-3GPP connection, and negotiate the corresponding identity authentication manner for the PIN element, with the PIN element.

It should be noted that, in the embodiments of the present disclosure, a secure non-3GPP connection may be established between the PIN element and the PEGC. In some embodiments, the PIN element may be preconfigured with a default credential, which may be generated by a third-party AAA server. The third-party AAA server is configured to maintain a mapping relationship between the PIN element identifier and the default credential for each PIN element.

In some embodiments, the PEGC may be registered to a 5G system. The connection between the PEGC and the access and mobility management function (AMF) may be protected by the security of the non-access stratum (NAS).

In some embodiments, first request information sent by a PIN element is received, where the first request information is used to request for assigning a credential to the PIN element. The first request information indicates at least one of the following: a credential provisioning indicator, or a PIN element identifier.

In some embodiments, the credential provisioning indicator may be used to indicate that the PIN element needs to request for credential provisioning in a user plane or control plane manner; and the PIN element identifier may be plaintext or ciphertext.

The first network function may include an access and mobility management function (AMF). Those skilled in the art should understand that, when another network element of the core network implements the function of the AMF, another network element of the core network may also be enabled as the first network function. Alternatively, when another network function of the core network is configured with the corresponding function of the first network function in the embodiments of the present disclosure, another network function of the core network may also be enabled as the first network function.

In some embodiments, a secure connection with the PIN element is established by the PIN element gateway through the non-3GPP connection. The first request information sent by the PIN element to the PIN element gateway is received, where the first request information is used to request for assigning a credential to the personal IoT network (PIN) element. In response to the PIN element gateway receiving the first request information, sixth request information is sent to the first network function. Here, the sixth request information may be sent to the first network function through a NAS message. It should be noted that the PEGC is also a PIN element, which does not need to be triggered by another PIN element, and may directly send the sixth request information of the PEGC to the first network function.

For example, the sixth request information may be sent to the first network function based on a protected manner. For example, the sixth request information may be sent to the first network function through a non-access stratum (NAS) message.

In some embodiments, the sixth request information is sent to the first network function, where the sixth request information is used to request for assigning a credential to a personal IoT network (PIN) element. The authentication result information sent by the first network function is received, where the authentication result information indicates successful authentication or authentication failure. In some embodiments, in response to the authentication result information indicating successful authentication, a protocol data unit (PDU) session for operator credential provisioning is requested to be established. In this way, the operator credential may be obtained based on the PDU session.

In some embodiments, the authentication result information includes at least one of the following:
a credential provisioning indicator;
a PIN element identifier;
information indicating successful authentication;
a fully qualified domain name (FQDN) of a provisioning server (PVS);
address information of the PVS; or
a user plane credential provisioning indicator.

Here, the user plane credential provisioning indicator is used to indicate that the following credential provisioning needs to be performed in a user plane manner.

In some embodiments, the information indicating successful authentication indicates an effective time of the information indicating successful authentication.

It should be noted that the information indicating successful authentication includes a validity period. After the validity period is expired, the information indicating successful authentication is invalid. The PVS no longer recognizes that the PIN element authentication is successful, or no longer provisions a credential to the PIN element.

It should be noted that the authentication result information may also be split into different forms of information, for example, it may be split into authentication result information and address information, which is not limited here.

In some embodiments, in response to receiving the authentication result information, address information or a fully qualified domain name of the PVS is sent to the PIN element. Here, the authentication result information may be sent to the PIN element through the secure non-3GPP connection. In this way, the PIN element may request the PVS to provision the operator credential according to the address information or the fully qualified domain name of the PVS.

In some embodiments, the first request information sent by the PIN element to the PIN element gateway is received, where the first request information is used to request for assigning a credential to a personal IoT network (PIN) element. In response to the PIN element gateway receiving the first request information, the sixth request information is sent to the first network function. The authentication result information sent by the first network function is received, where the authentication result information indicates successful authentication or authentication failure. The authentication result information is sent to the PIN element.

It should be noted that those skilled in the art may understand that the method provided in the embodiments of the present disclosure may be performed separately, or may be performed together with some methods in the embodiments of the present disclosure or some methods in the related art.

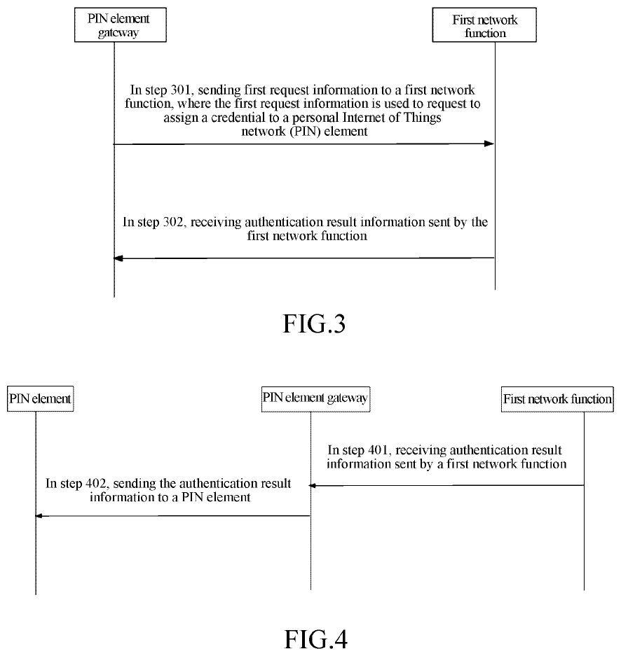

FIG. 3 is a schematic flowchart of a method for personal IoT network (PIN) element credential provisioning shown according to some embodiments of the present disclosure. As shown in FIG. 3, the method for personal IoT network (PIN) element credential provisioning according to embodiments of the present disclosure is applied to a PIN element gateway, and the method for personal IoT network (PIN) element credential provisioning includes the following processing steps.

In step 301, sixth request information is sent to a first network function, where the sixth request information is used to request for assigning a credential to a personal IoT network (PIN) element.

In step 302, authentication result information sent by the first network function is received.

In some embodiments, the sixth request information indicates at least one of the following:
a credential provisioning indicator;
a PIN element identifier; or
a PIN element gateway identifier.

In some embodiments, the credential provisioning indicator may be used to indicate that the PIN element needs to request for credential provisioning in a user plane or control plane manner; and the PIN element identifier may be plaintext or ciphertext. The PIN element gateway identifier may be a subscription concealed identifier (SUCI) and/or a globally unique temporary UE identifier (GUTI).

Here, the sixth request information may be information carried by the non-access stratum message. Those skilled in the art should understand that the NAS message is used only for the consideration of security, and other types of messages may also be used to implement the foregoing information transmission.

The first network function may include an access and mobility management function (AMF). Those skilled in the art should understand that, when another network element of the core network implements the function of the AMF, another network element of the core network may also be enabled as the first network function. Alternatively, when another network function of the core network is configured with the corresponding function of the first network function in the embodiments of the present disclosure, another network function of the core network may also be enabled as the first network function.

In some embodiments, a secure connection with the PIN element gateway is established by the PIN element through the non-3GPP connection. The first request information sent by the PIN element to the PIN element gateway is received, where the first request information is used to request for assigning a credential to the personal IoT network (PIN) element. In response to UE receiving the first request information, the sixth request information is sent to the first network function, where the sixth request information is used to request for assigning a credential to the personal IoT network (PIN) element. Here, the sixth request information may be sent to the first network function through a NAS message. It should be noted that the PEGC is also a PIN element, which does not need to be triggered by another PIN element, and may directly send the sixth request information of the PEGC to the first network function.

For example, the sixth request information may be sent to the first network function based on a protected manner. For example, the sixth request information may be sent to the first network function through a non-access stratum (NAS) message.

In some embodiments, the first request information is sent to the first network function, where the first request information is used to request for assigning a credential to a personal IoT network (PIN) element. The authentication result information sent by the first network function is received, where the authentication result information indicates successful authentication or authentication failure. In response to the authentication result information indicating successful authentication, a protocol data unit (PDU) session for operator credential provisioning is requested to be established. In this way, the operator credential may be obtained based on the PDU session.

In some embodiments, the authentication result information includes at least one of the following:
a credential provisioning indicator;
a PIN element identifier;
information indicating successful authentication;
a fully qualified domain name (FQDN) of a provisioning server (PVS);
address information of the PVS; or
a user plane credential provisioning indicator.

Here, the user plane credential provisioning indicator is used to indicate that the following credential provisioning needs to be performed in a user plane manner.

The information indicating successful authentication indicates an effective time of the information indicating successful authentication.

It should be noted that the information indicating successful authentication includes a validity period. After the validity period is expired, the information indicating successful authentication is invalid. The PVS no longer recognizes that the PIN element authentication is successful, or no longer provisions a credential to the PIN element.

It should be noted that the authentication result information may also be split into different forms of information, for example, it may be split into authentication result information and address information, which is not limited here.

In some embodiments, in response to receiving the authentication result information, address information or a fully qualified domain name of the PVS is sent to the PIN element. Here, the authentication result information may be sent to the PIN element through the secure non-3GPP connection. In this way, the PIN element may request the PVS to provision the operator credential according to the address information or the fully qualified domain name of the PVS.

In some embodiments, the first request information sent by the PIN element to the PIN element gateway is received, where the first request information is used to request for assigning a credential to a personal IoT network (PIN) element. In response to the PIN element gateway receiving the first request information, the sixth request information is sent to the first network function. The authentication result information sent by the first network function is received, where the authentication result information indicates successful authentication or authentication failure. The authentication result information is sent to the PIN element.

It should be noted that those skilled in the art may understand that the method provided in the embodiments of the present disclosure may be performed separately, or may be performed together with some methods in the embodiments of the present disclosure or some methods in the related art.

FIG. 4 is a schematic flowchart of a method for personal IoT network (PIN) element credential provisioning shown according to some embodiments of the present disclosure. As shown in FIG. 4, the method for personal IoT network (PIN) element credential provisioning according to embodiments of the present disclosure is applied to a PIN element gateway, and the method for personal IoT network (PIN) element credential provisioning includes the following processing steps.

In step 401, authentication result information sent by a first network function is received.

In some embodiments, the authentication result information includes at least one of the following:
a credential provisioning indicator;
a PIN element identifier;
information indicating successful authentication;
a fully qualified domain name (FQDN) of a provisioning server (PVS);
address information of a provisioning server (PVS); or
a user plane credential provisioning indicator.

In step 402, the authentication result information is sent to a PIN element.

In some embodiments, the sixth request information is sent to the first network function, where the sixth request information is used to request for assigning a credential to a personal IoT network (PIN) element. The authentication result information sent by the first network function is received, where the authentication result information indicates successful authentication or authentication failure.

In some embodiments, the sixth request information indicates at least one of the following:
a credential provisioning indicator;
a PIN element identifier; or
a PIN element gateway identifier.

In some embodiments, the credential provisioning indicator may be used to indicate that the PIN element needs to request for credential provisioning in a user plane or control plane manner; and the PIN element identifier may be plaintext or ciphertext. The PIN element gateway identifier may be a subscription concealed identifier (SUCI) and/or a globally unique temporary UE identifier (GUTI).

In some embodiments, in response to the authentication result information indicating successful authentication, a protocol data unit (PDU) session for operator credential provisioning is requested to be established. In this way, the operator credential may be obtained based on the PDU session.

In some embodiments, in response to receiving the authentication result information, address information or a fully qualified domain name of the PVS is sent to the PIN element. Here, the authentication result information may be sent to the PIN element through the secure non-3GPP connection. In this way, the PIN element may request the PVS to provision the operator credential according to the address information or the fully qualified domain name of the PVS.

In some embodiments, the first request information sent by the PIN element to the PIN element gateway is received, where the first request information is used to request for assigning a credential to a personal IoT network (PIN) element. In response to the PIN element gateway receiving the first request information, the sixth request information is sent to the first network function. The authentication result information sent by the first network function is received, where the authentication result information indicates successful authentication or authentication failure. The authentication result information is sent to the PIN element.

It should be noted that those skilled in the art may understand that the method provided in the embodiments of the present disclosure may be performed separately, or may be performed together with some methods in the embodiments of the present disclosure or some methods in the related art.

FIG. 5 is a schematic flowchart of a method for personal IoT network (PIN) element credential provisioning shown according to some embodiments of the present disclosure. As shown in FIG. 5, the method for personal IoT network (PIN) element credential provisioning according to embodiments of the present disclosure is applied to a PIN element, and the method for personal IoT network (PIN) element credential provisioning includes the following processing steps.

In step 501, first request information is sent to a PIN element gateway, where the first request information is used to request for assigning a credential to a PIN element.

In step 502, authentication result information sent by the PIN element gateway is received.

Here, the PIN element and/or the PIN element gateway involved in the present disclosure may be a terminal, and the terminal may be, but is not limited to, a mobile phone, a wearable device, a vehicle-mounted terminal, a road side unit (RSU), a smart home terminal, an industrial sensing device, and/or a medical device, etc. In some embodiments, the PIN element and/or the PIN element gateway may be a Redcap terminal or a new radio (NR) terminal in a predetermined version (e.g., NR terminal in R17).

The network function involved in the present disclosure may be various types of network functions, such as, network functions of a 5th generation mobile communication (5G) network, or other evolved network functions.

In this embodiment of the present disclosure, the terminal may be used as an access gateway of a PIN element; that is, the terminal may be enabled as a private IoT gateway, such as a PEGC. The PIN element may access the 5G mobile network through the terminal. The PIN element itself may also be a terminal.

A terminal used as a PEGC may negotiate how to establish a secure non-3GPP connection, and negotiate the corresponding identity authentication manner for the PIN element, with the PIN element.

It should be noted that, in the embodiments of the present disclosure, a secure non-3GPP connection may be established between the PIN element and the PEGC. In some embodiments, the PIN element may be preconfigured with a default credential, which may be generated by a third-party AAA server. The third-party AAA server is configured to maintain a mapping relationship between the PIN element identifier and the default credential for each PIN element.

In some embodiments, the PEGC may be registered to a 5G system. The connection between the PEGC and the access and mobility management function (AMF) may be protected by the security of the non-access stratum (NAS).

In some embodiments, in response to the PIN element accessing the PIN, the first request information is sent to the PIN element gateway, where the first request information is used to request for assigning a credential to the PIN element.
the first request information indicates at least one of the following:
a credential provisioning indicator; or a PIN element identifier.

In some embodiments, the credential provisioning indicator may be used to indicate that the PIN element needs to request for credential provisioning in a user plane or control plane manner; and the PIN element identifier may be plaintext or ciphertext.

In some embodiments, a secure connection between the PIN element and the PIN element gateway is established; and the first request information is sent to the PIN element gateway based on the secure connection.

It should be noted that, here, the first request information may be information carried by the non-access stratum message. Those skilled in the art should understand that the NAS message is used only for the consideration of security, and other types of messages may also be used to implement the foregoing information transmission.

In some embodiments, the first request information is sent to a PIN element gateway, where the first request information is used to request for assigning a credential to a PIN element. The authentication result information sent by the PIN element gateway is received.

In some embodiments, the authentication result information includes at least one of the following:
a credential provisioning indicator;
information indicating successful authentication;
a fully qualified domain name (FQDN) of a provisioning server (PVS);
address information of a provisioning server (PVS); or
a user plane credential provisioning indicator.

Here, the user plane credential provisioning indicator is used to indicate that the following credential provisioning needs to be performed in a user plane manner.

It should be noted that, after obtaining the authentication result information, the PIN element may request to the PVS for the operator credential based on the authentication result information. After obtaining the operator credential, the PIN service may be performed.

The information indicating successful authentication indicates an effective time of the information indicating successful authentication.

It should be noted that the information indicating successful authentication includes a validity period. After the validity period is expired, the information indicating successful authentication is invalid. The PVS no longer recognizes that the PIN element authentication is successful, or no longer provisions a credential to the PIN element.

In some embodiments, the PIN element is preconfigured with at least one of the following: an FQDN, or address information of a PVS.

In some embodiments, the PIN element sends the first request information to the PIN element gateway, where the first request information is used to request for assigning a credential to the personal IoT network (PIN) element. In response to the PIN element gateway receiving the first request information, the PIN element gateway sends the sixth request information to the first network function. The PIN element gateway receives the authentication result information sent by the first network function, where the authentication result information indicates successful authentication or authentication failure. The PIN element gateway sends the authentication result information to the PIN element. The PIN element receives the authentication result information sent by the PIN element gateway.

It should be noted that those skilled in the art may understand that the method provided in the embodiments of the present disclosure may be performed separately, or may be performed together with some methods in the embodiments of the present disclosure or some methods in the related art.

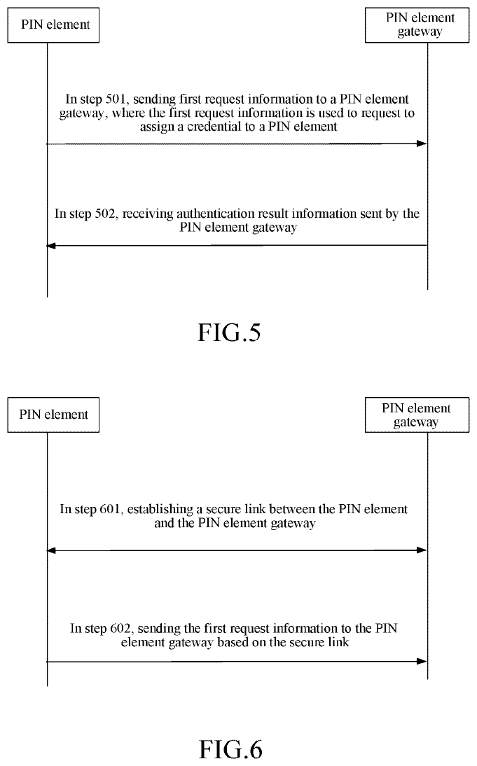

FIG. 6 is a schematic flowchart of a method for personal IoT network (PIN) element credential provisioning shown according to some embodiments of the present disclosure. As shown in FIG. 6, the method for personal IoT network (PIN) element credential provisioning according to embodiments of the present disclosure is applied to a PIN element, and the method for personal IoT network (PIN) element credential provisioning includes the following processing steps.

In step 601, a secure connection between the PIN element and the PIN element gateway is established.

In step 602, the first request information is sent to the PIN element gateway based on the secure connection.

In some embodiments, a secure connection between the PIN element and the PIN element gateway is established; and the first request information is sent to the PIN element gateway based on the secure connection, where the first request information is used to request for assigning a credential to a PIN element. The first request information indicates at least one of the following:
a credential provisioning indicator; or
a PIN element identifier.

In some embodiments, a secure connection between the PIN element and the PIN element gateway is established; and the first request information is sent to the PIN element gateway based on the secure connection.

In some embodiments, the first request information is sent to a PIN element gateway, where the first request information is used to request for assigning a credential to a PIN element.

The authentication result information sent by the PIN element gateway is received. The authentication result information includes at least one of the following:
a credential provisioning indicator;
information indicating successful authentication;
a fully qualified domain name (FQDN) of a provisioning server (PVS);
address information of a provisioning server (PVS); or
a user plane credential provisioning indicator.

Here, the user plane credential provisioning indicator is used to indicate that the following credential provisioning needs to be performed in a user plane manner.

The information indicating successful authentication indicates an effective time of the information indicating successful authentication.

It should be noted that the information indicating successful authentication includes a validity period. After the validity period is expired, the information indicating successful authentication is invalid. The PVS no longer recognizes that the PIN element authentication is successful, or no longer provisions a credential to the PIN element.

It should be noted that, after obtaining the authentication result information, the PIN element may request to the PVS for the operator credential based on the authentication result information. After obtaining the operator credential, the PIN service may be performed.

In some embodiments, the PIN element establishes a secure connection between the PIN element and the PIN element gateway. The PIN element sends the first request information to the PIN element gateway based on the secure connection, where the first request information is used to request for assigning a credential to a personal IoT network (PIN) element. In response to the PIN element gateway receiving the first request information, the PIN element gateway sends the sixth request information to the first network function. The PIN element gateway receives the authentication result information sent by the first network function, where the authentication result information indicates successful authentication or authentication failure. The PIN element gateway sends the authentication result information to the PIN element. The PIN element receives the authentication result information sent by the PIN element gateway.

It should be noted that those skilled in the art may understand that the method provided in the embodiments of the present disclosure may be performed separately, or may be performed together with some methods in the embodiments of the present disclosure or some methods in the related art.

FIG. 7 is a schematic flowchart of a method for personal IoT network (PIN) element credential provisioning shown according to some embodiments of the present disclosure. As shown in FIG. 7, the method for personal IoT network (PIN) element credential provisioning according to embodiments of the present disclosure is applied to a PIN element, and the method for personal IoT network (PIN) element credential provisioning includes the following processing steps.

In step 701, authentication result information sent by a PIN element gateway is received.

In step 702, in response to the authentication result information indicating successful authentication, the PIN network is accessed.

In some embodiments, the first request information is sent to a PIN element gateway, where the first request information is used to request for assigning a credential to a PIN element. The authentication result information sent by the PIN element gateway is received. In response to the authentication result information indicating successful authentication, the PIN network is accessed.

The first request information indicates at least one of the following:
a credential provisioning indicator; or
a PIN element identifier.

The authentication result information includes at least one of the following:
a credential provisioning indicator;
information indicating successful authentication;
a fully qualified domain name (FQDN) of a provisioning server (PVS);
address information of a provisioning server (PVS); or
a user plane credential provisioning indicator.

Here, the user plane credential provisioning indicator is used to indicate that the following credential provisioning needs to be performed in a user plane manner.

The information indicating successful authentication indicates an effective time of the information indicating successful authentication.

It should be noted that the information indicating successful authentication includes a validity period. After the validity period is expired, the information indicating successful authentication is invalid. The PVS no longer recognizes that the PIN element authentication is successful, or no longer provisions a credential to the PIN element.

It should be noted that, after obtaining the authentication result information, the PIN element may request to the PVS for the operator credential based on the authentication result information. After obtaining the operator credential, the PIN service may be performed.

It should be noted that those skilled in the art may understand that the method provided in the embodiments of the present disclosure may be performed separately, or may be performed together with some methods in the embodiments of the present disclosure or some methods in the related art.

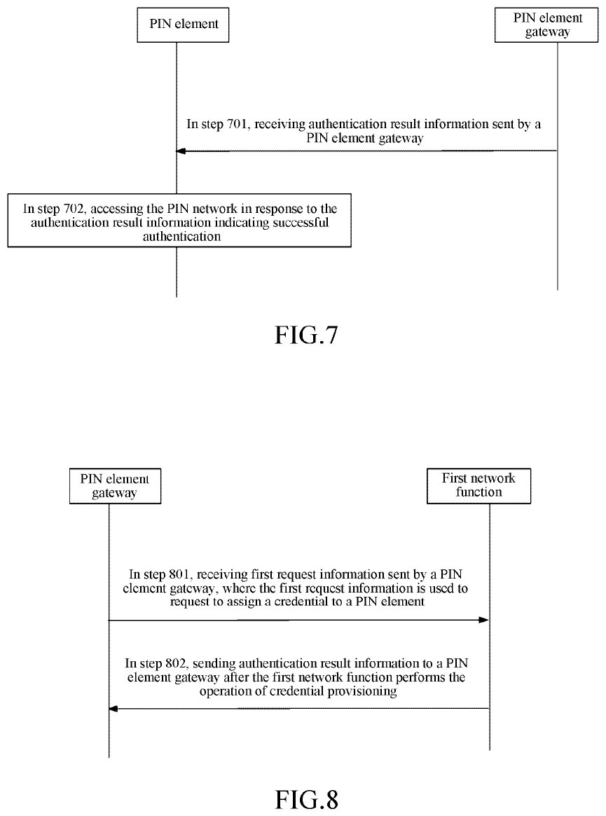

FIG. 8 is a schematic flowchart of a method for personal IoT network (PIN) element credential provisioning shown according to some embodiments of the present disclosure. As shown in FIG. 8, the method for personal IoT network (PIN) element credential provisioning according to embodiments of the present disclosure is applied to a first network function, and the method for personal IoT network (PIN) element credential provisioning includes the following processing steps.

In step 801, sixth request information sent by a PIN element gateway is received, where the sixth request information is used to request for assigning a credential to a PIN element.

In step 802, authentication result information is sent to the PIN element gateway after the first network function performs the operation of credential provisioning.

Here, the PIN element and/or the PIN element gateway involved in the present disclosure may be a terminal, and the terminal may be, but is not limited to, a mobile phone, a wearable device, a vehicle-mounted terminal, a road side unit (RSU), a smart home terminal, an industrial sensing device, and/or a medical device, etc. In some embodiments, the PIN element and/or the PIN element gateway may be a Redcap terminal or a new radio (NR) terminal in a predetermined version (e.g., NR terminal in R17).

The network functions involved in the present disclosure may be various types of network functions, such as, network functions of a 5th generation mobile communication (5G) network, or other evolved network functions.

In the embodiments of the present disclosure, the terminal may be used as an access gateway of a PIN element; that is, the terminal may be enabled as a private IoT gateway, such as a PEGC. The PIN element may access the 5G mobile network through the terminal. The PIN element itself may also be a terminal.

A terminal used as a PEGC may negotiate how to establish a secure non-3GPP connection, and negotiate the corresponding identity authentication manner for the PIN element, with the PIN element.

It should be noted that, in the embodiments of the present disclosure, a secure non-3GPP connection may be established between the PIN element and the PEGC. In some embodiments, the PIN element may be preconfigured with a default credential, which may be generated by a third-party AAA server. The third-party AAA server is configured to maintain a mapping relationship between the PIN element identifier and the default credential for each PIN element.

In some embodiments, the PEGC may be registered to a 5G system. The connection between the PEGC and the access and mobility management function (AMF) may be protected by the security of the non-access stratum (NAS).

In some embodiments, the sixth request information indicates at least one of the following: a credential provisioning indicator;
a PIN element identifier; or
a PIN element gateway identifier.

In some embodiments, the credential provisioning indicator may be used to indicate that the PIN element needs to request for credential provisioning in a user plane or control plane manner; and the PIN element identifier may be plaintext or ciphertext. The PIN element gateway identifier may be a subscription concealed identifier (SUCI) and/or a globally unique temporary UE identity (GUTI).

Here, the sixth request information may be information carried by the non-access stratum message. Those skilled in the art should understand that the NAS message is used only for the consideration of security, and other types of messages may also be used to implement the foregoing information transmission.

The first network function may include an access and mobility management function (AMF). Those skilled in the art should understand that, when another network element of the core network implements the function of the AMF, another network element of the core network may also be enabled as the first network function. Alternatively, when another network function of the core network is configured with the corresponding function of the first network function in the embodiments of the present disclosure, another network function of the core network may also be enabled as the first network function.

In some embodiments, a secure connection with the PIN element is established by the PIN element gateway through the non-3GPP connection. The PIN element gateway receives first request information sent by the PIN element to the PIN element gateway, where the first request information is used to request for assigning a credential to the personal IoT network (PIN) element. In response to the PIN element gateway receiving the first request information, the PIN element gateway sends the sixth request information to the first network function. The first network function receives the sixth request information sent by the PIN element gateway. Here, the sixth request information sent to the first network function by the PIN element gateway may be received through a NAS message.

For example, the sixth request information sent by the PIN element gateway to the first network function may be received based on a protected manner. For example, the sixth request information sent by the PIN element gateway to the first network function may be received through a non-access stratum (NAS) message.

In some embodiments, first request information sent by a PIN element gateway to a first network function is received, where the first request information is used to request for assigning a credential to a personal IoT network (PIN) element. sending authentication result information to the PIN element gateway, where the authentication result information indicates that the authentication succeeds or the authentication fails.

In some embodiments, the authentication result information includes at least one of the following:
a credential provisioning indicator;
a PIN element identifier;
a PIN element gateway identifier (e.g., an SUCI);
information indicating successful authentication;
a fully qualified domain name (FQDN) of a provisioning server (PVS);
address information of a PVS; or
a user plane credential provisioning indicator.

The information indicating successful authentication indicates an effective time of the information indicating successful authentication.

It should be noted that the information indicating successful authentication includes a validity period. After the validity period is expired, the information indicating successful authentication is invalid. The PVS no longer recognizes that the PIN element authentication is successful, or no longer provisions a credential to the PIN element.

It should be noted that the authentication result information may also be split into different forms of information, for example, it may be split into authentication result information and address information, which is not limited here.

In some embodiments, the first request information sent by a PIN element gateway is received, where the first request information is used to request for assigning a credential to a personal IoT network (PIN) element. In response to receiving the first request information, authentication of the PIN element is initiated. For example, initiating authentication of the PIN element may be sending second request information to a second network function, where the second request information is used to initiate authentication of the PIN element.

In some embodiments, the second request information includes at least one of the following:
a credential provisioning indicator;
a PIN element identifier;
a subscription concealed identifier (SUCI) of a PIN element gateway; or
a name of a serving network (SN).

In some embodiments, the PIN element sends the first request information to the PIN element gateway, where the first request information is used to request for assigning a credential to a personal IoT network (PIN) element. In response to the PIN element gateway receiving the first request information, the PIN element gateway sends the sixth request information to the first network function. After receiving the sixth request information, the first network function sends the authentication result information to the PIN element gateway. The PIN element gateway receives the authentication result information sent by the first network function. The PIN element gateway sends the authentication result information to the PIN element. The PIN element receives the authentication result information sent by the PIN element gateway.

It should be noted that those skilled in the art may understand that the method provided in the embodiments of the present disclosure may be performed separately, or may be performed together with some methods in the embodiments of the present disclosure or some methods in the related art.

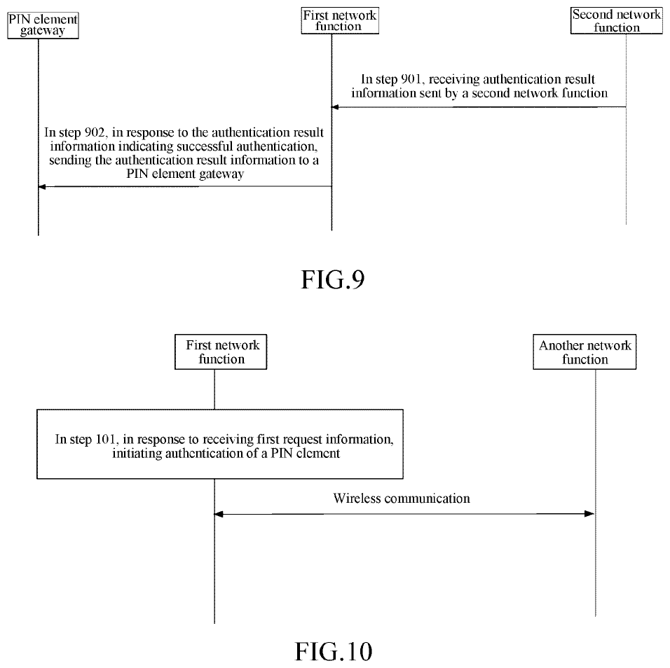

FIG. 9 is a schematic flowchart of a method for personal IoT network (PIN) element credential provisioning shown according to some embodiments of the present disclosure. As shown in FIG. 9, the method for personal IoT network (PIN) element credential provisioning according to embodiments of the present disclosure is applied to a first network function, and the method for personal IoT network (PIN) element credential provisioning includes the following processing steps.

In step 901, authentication result information sent by a second network function is received;

In step 902, in response to the authentication result information indicating successful authentication, the authentication result information is sent to the PIN element gateway.

In some embodiments, the sixth request information indicates at least one of the following:
a credential provisioning indicator;
a PIN element identifier; or
a PIN element gateway identifier.

In some embodiments, the credential provisioning indicator may be used to indicate that the PIN element needs to request for credential provisioning in a user plane or control plane manner; and the PIN element identifier may be plaintext or ciphertext. The PIN element gateway identifier may be a subscription concealed identifier (SUCI) and/or a globally unique temporary UE identifier (GUTI).

In some embodiments, a secure connection with the PIN element is established by the PIN element gateway through a non-3GPP connection. The PIN element gateway receives the first request information sent by the PIN element to the PIN element gateway, where the first request information is used to request for assigning a credential to the personal IoT network (PIN) element. In response to the PIN element gateway receiving the first request information, the PIN element gateway sends the sixth request information to the first network function. The first network function receives the sixth request information sent by the PIN element gateway. In response to receiving the sixth request information, authentication of the PIN element is initiated.

In some embodiments, the second request information is sent to a second network function, where the second request information is used to initiate authentication of the PIN element. Authentication result information sent by the second network function is received; and in response to the authentication result information indicating successful authentication, the authentication result information is sent to the PIN element gateway.

In some embodiments, the authentication result information includes at least one of the following:
a credential provisioning indicator;
a PIN element identifier;
a PIN element gateway identifier (e.g., an SUCI);
information indicating successful authentication;
a fully qualified domain name (FQDN) of a provisioning server (PVS);
address information of a PVS; or
a user plane credential provisioning indicator.

The information indicating successful authentication indicates an effective time of the information indicating successful authentication.

It should be noted that the information indicating successful authentication includes a validity period. After the validity period is expired, the information indicating successful authentication is invalid. The PVS no longer recognizes that the PIN element authentication is successful, or no longer provisions a credential to the PIN element.

It should be noted that the authentication result information may also be split into different forms of information, for example, it may be split into authentication result information and address information, which is not limited here.

In some embodiments, the first request information sent by a PIN element gateway is received, where the first request information is used to request for assigning a credential to a personal IoT network (PIN) element. In response to receiving the first request information, authentication of the PIN element is initiated. For example, initiating authentication of the PIN element may be sending the second request information to the second network function, where the second request information is used to initiate authentication of the PIN element.

In some embodiments, the second request information includes at least one of the following:
a credential provisioning indicator;
a PIN element identifier;
a subscription concealed identifier (SUCI) of a PIN element gateway; or
a name of a serving network (SN).

In some embodiments, the PIN element sends the first request information to the PIN element gateway, where the first request information is used to request for assigning a credential to a personal IoT network (PIN) element. In response to the PIN element gateway receiving the first request information, the PIN element gateway sends the sixth request information to the first network function. The first network function receives the sixth request information. The first network function receives the authentication result information sent by the second network function. In response to the authentication result information indicating successful authentication, the authentication result information is sent to the PIN element gateway. The PIN element gateway receives the authentication result information sent by the first network function. The PIN element gateway sends the authentication result information to the PIN element. The PIN element receives the authentication result information sent by the PIN element gateway.

It should be noted that those skilled in the art may understand that the method provided in the embodiments of the present disclosure may be performed separately, or may be performed together with some methods in the embodiments of the present disclosure or some methods in the related art.

FIG. 10 is a schematic flowchart of a method for personal IoT network (PIN) element credential provisioning shown according to some embodiments of the present disclosure. As shown in FIG. 10, the method for personal IoT network (PIN) element credential provisioning according to embodiments of the present disclosure is applied to a first network function, and the method for personal IoT network (PIN) element credential provisioning includes the following processing steps.

In step 101, in response to receiving sixth request information, authentication of the PIN element is initiated.

In some embodiments, the sixth request information indicates at least one of the following:
a credential provisioning indicator;
a PIN element identifier; or
a PIN element gateway identifier.

In some embodiments, the credential provisioning indicator may be used to indicate that the PIN element needs to request for credential provisioning in a user plane or control plane manner; and the PIN element identifier may be plaintext or ciphertext. The PIN element gateway identifier may be a subscription concealed identifier (SUCI) and/or a globally unique temporary UE identity (GUTI).

In some embodiments, a secure connection with the PIN element is established by the PIN element gateway through a non-3GPP connection. The PIN element gateway receives first request information sent by the PIN element to the PIN element gateway, where the first request information is used to request for assigning a credential to the personal IoT network (PIN) element. In response to the PIN element gateway receiving the first request information, the PIN element gateway sends the sixth request information to the first network function. The first network function receives the sixth request information sent by the PIN element gateway. In response to receiving the sixth request information, authentication of the PIN element is initiated.

In some embodiments, second request information is sent to a second network function, where the second request information is used to initiate authentication of the PIN element. Authentication result information sent by the second network function is received; and in response to the authentication result information indicating successful authentication, the authentication result information is sent to the PIN element gateway.

In some embodiments, the authentication result information includes at least one of the following:
a credential provisioning indicator;
a PIN element identifier;
a PIN element gateway identifier (e.g., an SUCI);
information indicating successful authentication;
a fully qualified domain name (FQDN) of a provisioning server (PVS); address information of a PVS; or
a user plane credential provisioning indicator.

The information indicating successful authentication indicates an effective time of the information indicating successful authentication.

It should be noted that the information indicating successful authentication includes a validity period. After the validity period is expired, the information indicating successful authentication is invalid. The PVS no longer recognizes that the PIN element authentication is successful, or no longer provisions a credential to the PIN element.

It should be noted that the authentication result information may also be split into different forms of information, for example, it may be split into authentication result information and address information, which is not limited here.

In some embodiments, the first request information sent by a PIN element gateway is received, where the first request information is used to request for assigning a credential to a personal IoT network (PIN) element. In response to receiving the first request information, authentication of the PIN element is initiated. For example, initiating authentication of the PIN element may be sending second request information to the second network function, where the second request information is used to initiate authentication of the PIN element.

In some embodiments, the second request information includes at least one of the following:
a credential provisioning indicator;
a PIN element identifier;
a subscription concealed identifier (SUCI) of a PIN element gateway; or
a name of a serving network (SN).

It should be noted that those skilled in the art may understand that the method provided in the embodiments of the present disclosure may be performed separately, or may be performed together with some methods in the embodiments of the present disclosure or some methods in the related art.

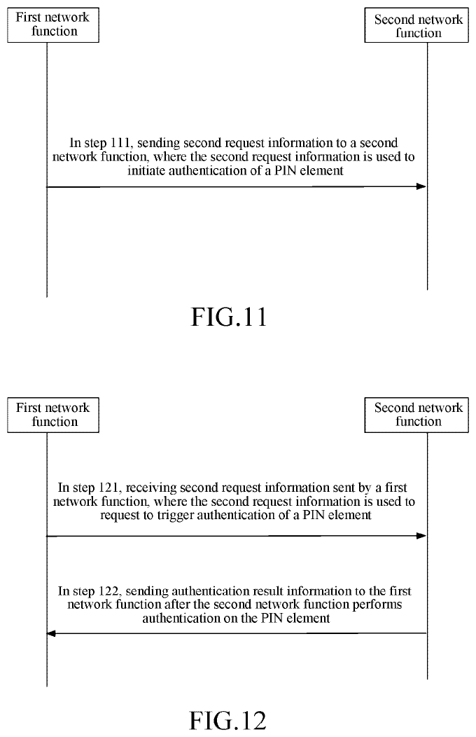

FIG. 11 is a schematic flowchart of a method for personal IoT network (PIN) element credential provisioning shown according to some embodiments of the present disclosure. As shown in FIG. 11, the method for personal IoT network (PIN) element credential provisioning according to embodiments of the present disclosure is applied to a first network function, and the method for personal IoT network (PIN) element credential provisioning includes the following processing steps.

In step 111, second request information is sent to a second network function.

In some embodiments, the second request information is used to initiate authentication of the PIN element.

In some embodiments, the second request information includes at least one of the following:
a credential provisioning indicator;
a PIN element identifier;
a PIN element gateway identifier; or
a name of a serving network (SN).

In some embodiments, the sixth request information indicates at least one of the following:
a credential provisioning indicator;
a PIN element identifier; or
a PIN element gateway identifier.

In some embodiments, the credential provisioning indicator may be used to indicate that the PIN element needs to request for credential provisioning in a user plane or control plane manner; and the PIN element identifier may be plaintext or ciphertext. The PIN element gateway identifier may be a subscription concealed identifier (SUCI) and/or a globally unique temporary UE identifier (GUTI).

In some embodiments, a secure connection with the PIN element is established by the PIN element gateway through a non-3GPP connection. The PIN element gateway receives first request information sent by the PIN element to the PIN element gateway, where the first request information is used to request for assigning a credential to a personal IoT network (PIN) element. In response to the PIN element gateway receiving the first request information, the PIN element gateway sends the sixth request information to the first network function. The first network function receives the sixth request information sent by the PIN element gateway. In response to receiving the sixth request information, second request information is sent to a second network function, where the second request information is used to initiate authentication of the PIN element.

In some embodiments, the second request information is sent to the second network function, where the second request information is used to initiate authentication of the PIN element. Authentication result information sent by the second network function is received; and in response to the authentication result information indicating successful authentication, the authentication result information is sent to the PIN element gateway.

In some embodiments, the authentication result information includes at least one of the following:
a credential provisioning indicator;
a PIN element identifier;
a PIN element gateway identifier (e.g., an SUCI);
information indicating successful authentication;
a fully qualified domain name (FQDN) of a provisioning server (PVS);
address information of a PVS; or
a user plane credential provisioning indicator.

The information indicating successful authentication indicates an effective time of the information indicating successful authentication.

It should be noted that the information indicating successful authentication includes a validity period. After the validity period is expired, the information indicating successful authentication is invalid. The PVS no longer recognizes that the PIN element authentication is successful, or no longer provisions a credential to the PIN element.

It should be noted that the authentication result information may also be split into different forms of information, for example, it may be split into authentication result information and address information, which is not limited here.

It should be noted that those skilled in the art may understand that the method provided in the embodiments of the present disclosure may be performed separately, or may be performed together with some methods in the embodiments of the present disclosure or some methods in the related art.

FIG. 12 is a schematic flowchart of a method for personal IoT network (PIN) element credential provisioning shown according to some embodiments of the present disclosure. As shown in FIG. 12, the method for personal IoT network (PIN) element credential provisioning according to embodiments of the present disclosure is applied to a second network function, and the method for personal IoT network (PIN) element credential provisioning includes the following processing steps.

In step 121, second request information sent by a first network function is received, where the second request information is used to request for triggering authentication of a PIN element.

In step 122, authentication result information is sent to the first network function after the second network function performs authentication of the PIN element.

The network functions involved in the present disclosure may be various types of network functions, such as, network functions of a 5th generation mobile communication (5G) network, or other evolved network functions.

In some embodiments, the second request information includes at least one of the following:
a credential provisioning indicator;
a PIN element identifier;
a PIN element gateway identifier; or
a name of a serving network (SN).

The first network function may include an access and mobility management function (AMF). Those skilled in the art should understand that, when another network function of the core network implements the function of the AMF, another network function of the core network may also be enabled as the first network function. Alternatively, when another network function of the core network is configured with the corresponding function of the first network function in the embodiments of the present disclosure, another network function of the core network may also be enabled as the first network function.

The second network function may include an authentication server function (AUSF). Those skilled in the art should understand that, when another network function of the core network implements the function of the AUSF, another network function of the core network may also be enabled as the second network function. Alternatively, when another network element of the core network is configured with the corresponding function of the second network function in the embodiments of the present disclosure, another network element of the core network may also be enabled as the second network function.

The third network function may include unified data management (UDM). Those skilled in the art should understand that, when another network function of the core network implements the function of the UDM, another network function of the core network may also be enabled as the third network function. Alternatively, when another network element of the core network is configured with the corresponding function of the third network function in the embodiments of the present disclosure, another network element of the core network may also be enabled as the third network function.

In some embodiments, the second request information sent by the first network function is received, where the second request information is used to request for authentication of a PIN element. In response to receiving the second request information, third request information is sent to a third network function, where the third request information is used to request for obtaining auxiliary information of a credential. The auxiliary information sent by the third network function is received. It should be noted that, in response to receiving the third request information, the third network function sends the auxiliary information to the second network function.

In some embodiments, the auxiliary information includes at least one of the following:
a PIN element gateway identifier;
an authentication manner;
a fully qualified domain name (FQDN) of a provisioning server (PVS); or
address information of a provisioning server (PVS).

The fourth network function may include a network slice-specific authentication and authorization function (NSSAAF). Those skilled in the art should understand that, when another network function of the core network implements the function of the NSSAAF, another network function of the core network may also be enabled as the fourth network function. Alternatively, when another network element of the core network is configured with the corresponding function of the fourth network function in the embodiments of the present disclosure, another network element of the core network may also be enabled as the fourth network function.

In some embodiments, after receiving the auxiliary information, the second network element determines the fourth network function based on the user permanent identifier (SUPI) of the PIN element gateway. The fourth request information is sent to the fourth network function, where the fourth request information is used to request for performing element authentication, and the fourth request information may indicate a PIN element identifier. The information indicating successful authentication sent by the fourth network function for the fourth request information is received. In response to the authentication result information indicating successful authentication, the authentication result notification process is initiated. For example, the notification information may be sent to an application function, where the notification information includes at least one of the following:
information indicating successful authentication;
a PIN element identifier; or
a PIN element gateway identifier.

Here, the application function may be a provisioning server (PVS).

In some embodiments, after receiving the authentication result information, the authentication result information is sent to the first network function, where the authentication result information includes at least one of the following:
a credential provisioning indicator;
a PIN element identifier;
a PIN element gateway identifier (e.g., an SUCI);
information indicating successful authentication;
a fully qualified domain name (FQDN) of a provisioning server (PVS);
address information of a PVS; or
a user plane credential provisioning indicator.

The information indicating successful authentication indicates an effective time of the information indicating successful authentication.

It should be noted that the information indicating successful authentication includes a validity period. After the validity period is expired, the information indicating successful authentication is invalid. The PVS no longer recognizes that the PIN element authentication is successful, or no longer provisions a credential to the PIN element.

It should be noted that those skilled in the art may understand that the method provided in the embodiments of the present disclosure may be performed separately, or may be performed together with some methods in the embodiments of the present disclosure or some methods in the related art.

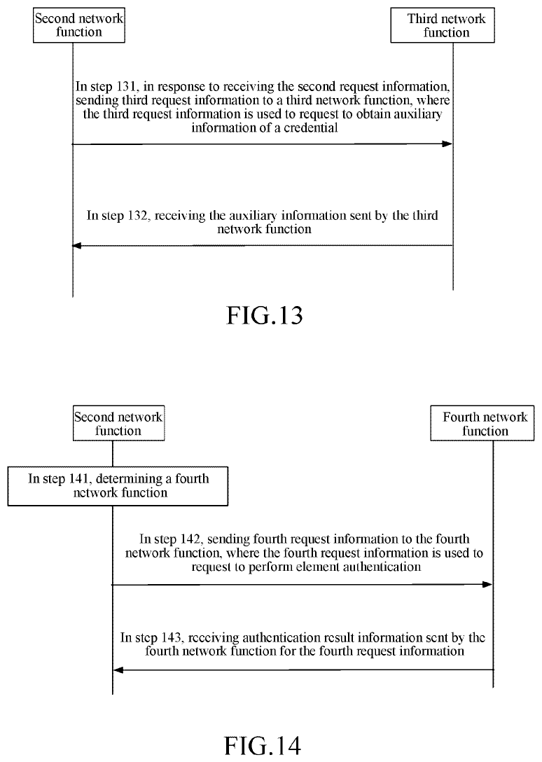

FIG. 13 is a schematic flowchart of a method for personal IoT network (PIN) element credential provisioning shown according to some embodiments of the present disclosure. As shown in FIG. 13, the method for personal IoT network (PIN) element credential provisioning according to embodiments of the present disclosure is applied to a second network function, and the method for personal IoT network (PIN) element credential provisioning includes the following processing steps.

In step 131, in response to receiving the second request information, third request information is sent to a third network function, where the third request information is used to request for obtaining auxiliary information of a credential.

In step 132, the auxiliary information sent by the third network function is received.

In some embodiments, the second request information sent by a first network function is received, where the second request information is used to request for authentication of the PIN element. In response to receiving the second request information, third request information is sent to a third network function, where the third request information is used to request for obtaining auxiliary information of a credential. The auxiliary information sent by the third network function is received. It should be noted that, in response to receiving the third request information, the third network function sends the auxiliary information to the second network function. The second network function receives the auxiliary information.

In some embodiments, the auxiliary information includes at least one of the following:
a PIN element gateway identifier;
an authentication manner;
a fully qualified domain name (FQDN) of a provisioning server (PVS); or
address information of a provisioning server (PVS).

It should be noted that those skilled in the art may understand that the method provided in the embodiments of the present disclosure may be performed separately, or may be performed together with some methods in the embodiments of the present disclosure or some methods in the related art.

FIG. 14 is a schematic flowchart of a method for personal IoT network (PIN) element credential provisioning shown according to some embodiments of the present disclosure. As shown in FIG. 14, the method for personal IoT network (PIN) element credential provisioning according to embodiments of the present disclosure is applied to a second network function, and the method for personal IoT network (PIN) element credential provisioning includes the following processing steps.

In step 141, a fourth network function is determined.

In step 142, fourth request information is sent to the fourth network function, where the fourth request information is used to request for performing element authentication.

In step 143, authentication result information sent by the fourth network function for the fourth request information is received.

In some embodiments, in response to obtaining the auxiliary information, the fourth request information is sent to the fourth network function.

In some embodiments, the preconfigured auxiliary information is obtained; or the auxiliary information is obtained from a third network function.

The network functions involved in the present disclosure may be various types of network functions, such as, network functions of a 5th generation mobile communication (5G) network, or other evolved network functions.

The second request information includes at least one of the following:
a credential provisioning indicator;
a PIN element identifier;
a PIN element gateway identifier; or
a name of a serving network (SN).

The first network function may include an access and mobility management function (AMF). Those skilled in the art should understand that, when another network function of the core network implements the function of the AMF, another network function may also be enabled as the first network function. Alternatively, when another network function of the core network is configured with the corresponding function of the first network function in the embodiments of the present disclosure, another network function may also be enabled as the first network function.

The second network function may include an authentication server function (AUSF). Those skilled in the art should understand that, when another network function of the core network implements the function of the AUSF, another network function of the core network may also be enabled as the second network function. Alternatively, when another network element of the core network is configured with the corresponding function of the second network function in the embodiments of the present disclosure, another network element of the core network may also be enabled as the second network function.

The third network function may include unified data management (UDM). Those skilled in the art should understand that, when another network function of the core network implements the function of the UDM, another network function of the core network may also be enabled as the third network function. Alternatively, when another network element of the core network is configured with the corresponding function of the third network function in the embodiments of the present disclosure, another network element of the core network may also be enabled as the third network function.

In some embodiments, the second request information sent by the first network function is received, where the second request information is used to request for authentication of a PIN element. In response to receiving the second request information, third request information is sent to a third network function, where the third request information is used to request for obtaining auxiliary information of a credential. The auxiliary information sent by the third network function is received. It should be noted that, in response to receiving the third request information, the third network function sends the auxiliary information to the second network function.

In some embodiments, the auxiliary information includes at least one of the following:
a PIN element gateway identifier;
an authentication manner;
a fully qualified domain name (FQDN) of a provisioning server (PVS); or
address information of a provisioning server (PVS).

The fourth network function may include a network slice-specific authentication and authorization function (NSSAAF). Those skilled in the art should understand that, when another network function of the core network implements the function of the NSSAAF, another network function of the core network may also be enabled as the fourth network function. Alternatively, when another network element of the core network is configured with the corresponding function of the fourth network function in the embodiments of the present disclosure, another network element of the core network may also be enabled as the fourth network function.

In some embodiments, after receiving the auxiliary information, the second network element determines the fourth network function based on the user permanent identifier (SUPI) of the element gateway. The fourth request information is sent to the fourth network function, where the fourth request information is used to request for performing element authentication, and the fourth request information may indicate a PIN element identifier. The information indicating successful authentication sent by the fourth network function for the fourth request information is received. In response to the authentication result information indicating successful authentication, the authentication result notification process is initiated. For example, the notification information may be sent to an application function, where the notification information includes at least one of the following:
information indicating successful authentication;
a PIN element identifier; or
a PIN element gateway identifier.

Here, the application function may be a provisioning server (PVS).

The information indicating successful authentication indicates an effective time of the information indicating successful authentication.

It should be noted that the information indicating successful authentication includes a validity period. After the validity period is expired, the information indicating successful authentication is invalid. The PVS no longer recognizes that the PIN element authentication is successful, or no longer provisions a credential to the PIN element.

In some embodiments, after receiving the authentication result information, the authentication result information is sent to the first network function, where the authentication result information includes at least one of the following:
a credential provisioning indicator;
a PIN element identifier;
a PIN element gateway identifier (e.g., an SUCI);
information indicating successful authentication;
a fully qualified domain name (FQDN) of a provisioning server (PVS);
address information of a PVS; or
a user plane credential provisioning indicator.

It should be noted that the information indicating successful authentication includes a validity period. After the validity period is expired, the information indicating successful authentication is invalid. The PVS no longer recognizes that the PIN element authentication is successful, or no longer provisions a credential to the PIN element.

It should be noted that those skilled in the art may understand that the method provided in the embodiments of the present disclosure may be performed separately, or may be performed together with some methods in the embodiments of the present disclosure or some methods in the related art.

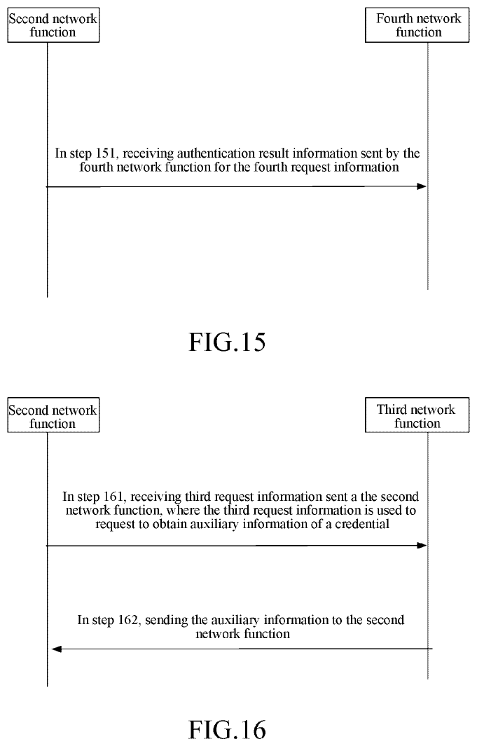

FIG. 15 is a schematic flowchart of a method for personal IoT network (PIN) element credential provisioning shown according to some embodiments of the present disclosure. As shown in FIG. 15, the method for personal IoT network (PIN) element credential provisioning according to embodiments of the present disclosure is applied to a second network function, and the method for personal IoT network (PIN) element credential provisioning includes the following processing steps.

In step 151, authentication result information sent by the fourth network function for the fourth request information is received.

The fourth network function may include a network slice-specific authentication and authorization function (NSSAAF). Those skilled in the art should understand that, when another network function of the core network implements the function of the NSSAAF, another network function of the core network may also be enabled as the fourth network function. Alternatively, when another network element of the core network is configured with the corresponding function of the fourth network function in the embodiments of the present disclosure, another network element of the core network may also be enabled as the fourth network function.

In some embodiments, after receiving the auxiliary information, the second network element determines the fourth network function based on the user permanent identifier (SUPI) of the element gateway. The fourth request information is sent to the fourth network function, where the fourth request information is used to request for performing element authentication, and the fourth request information may indicate a PIN element identifier. The information indicating successful authentication sent by the fourth network function for the fourth request information is received. In response to the authentication result information indicating successful authentication, the authentication result notification process is initiated. For example, the notification information may be sent to an application function, where the notification information includes at least one of the following:
information indicating successful authentication;
a PIN element identifier; or
a PIN element gateway identifier.

Here, the application function may be a provisioning server (PVS).

In some embodiments, after receiving the authentication result information, the authentication result information is sent to the first network function, where the authentication result information includes at least one of the following:
a credential provisioning indicator;
a PIN element identifier;
a PIN element gateway identifier (e.g., an SUCI);
information indicating successful authentication;
a fully qualified domain name (FQDN) of a provisioning server (PVS);
address information of a PVS; or
a user plane credential provisioning indicator.

In some embodiments, the information indicating successful authentication indicates an effective time of the information indicating successful authentication.

It should be noted that the information indicating successful authentication includes a validity period. After the validity period is expired, the information indicating successful authentication is invalid. The PVS no longer recognizes that the PIN element authentication is successful, or no longer provisions a credential to the PIN element.

It should be noted that those skilled in the art may understand that the method provided in the embodiments of the present disclosure may be performed separately, or may be performed together with some methods in the embodiments of the present disclosure or some methods in the related art.

FIG. 16 is a schematic flowchart of a method for personal IoT network (PIN) element credential provisioning shown according to some embodiments of the present disclosure. As shown in FIG. 16, the method for personal IoT network (PIN) element credential provisioning according to embodiments of the present disclosure is applied to a third second network function, and the method for personal IoT network (PIN) element credential provisioning includes the following processing steps.

In step 161, third request information sent by the second network function is received, where the third request information is used to request for obtaining auxiliary information of a credential.

In step 162, the auxiliary information is sent to the second network function.

The second network function may include an authentication server function (AUSF). Those skilled in the art should understand that, when another network function of the core network implements the function of the AUSF, another network function of the core network may also be enabled as the second network function. Alternatively, when another network function of the core network is configured with the corresponding function of the second network function in the embodiments of the present disclosure, another network function of the core network may also be enabled as the second network function.

The third network function may include unified data management (UDM). Those skilled in the art should understand that, when another network function of the core network implements the function of the UDM, another network function of the core network may also be enabled as the third network function. Alternatively, when another network element of the core network is configured with the corresponding function of the third network function in the embodiments of the present disclosure, another network element of the core network may also be enabled as the third network function.

In some embodiments, the second network function receives second request information sent by the first network function, where the second request information is used to request for authentication of the PIN element. In response to receiving the second request information, the second network function sends third request information to the third network function, where the third request information is used to request for obtaining auxiliary information of the credential. The third network function receives the third request information sent by the second network function. In response to determining that the PIN element gateway is a legal gateway, the auxiliary information is sent to the second network element; or, in response to determining that the PIN element gateway is an illegal gateway, the credential provisioning process is terminated.

In some embodiments, the auxiliary information includes at least one of the following: an element gateway identifier;
an authentication manner;
a fully qualified domain name (FQDN) of a provisioning server (PVS); or
address information of a provisioning server (PVS).

In some embodiments, whether the PIN element gateway is authorized as a legal gateway is checked according to subscription information of the PIN element gateway. In response to determining that the PIN element gateway is a legal gateway, the auxiliary information is sent to the second network function; or, in response to determining that the PIN element gateway is an illegal gateway, the credential provisioning process is terminated.

In some embodiments, in response to determining that the PIN element gateway is a legal gateway, an authentication manner for the PIN element is determined according to the predetermined information. For the third request information, the auxiliary information is sent to the second network function.

In some embodiments, the predetermined information includes at least one of the following:
a PIN element gateway identifier;
subscription data of a PIN element gateway;
a credential provisioning indicator; or
a PIN element identifier.

It should be noted that those skilled in the art may understand that the method provided in the embodiments of the present disclosure may be performed separately, or may be performed together with some methods in the embodiments of the present disclosure or some methods in the related art.

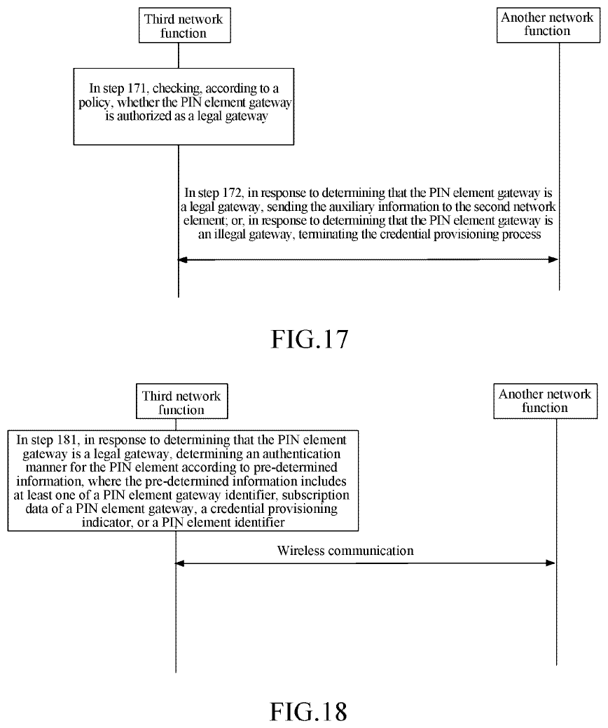

FIG. 17 is a schematic flowchart of a method for personal IoT network (PIN) element credential provisioning shown according to some embodiments of the present disclosure. As shown in FIG. 17, the method for personal IoT network (PIN) element credential provisioning according to embodiments of the present disclosure is applied to a third second network function, and the method for personal IoT network (PIN) element credential provisioning includes the following processing steps.

In step 171, whether the PIN element gateway is authorized as a legal gateway is checked according to a policy.

In step 172, in response to determining that the PIN element gateway is a legal gateway, the auxiliary information to is sent the second network element; or, in response to determining that the PIN element gateway is an illegal gateway, the credential provisioning process is terminated.

In some embodiments, whether the PIN element gateway is authorized as a legal gateway of the PIN element corresponding to the PIN element identifier is checked according to the policy.

In some embodiments, the second network function receives second request information sent by the first network function, where the second request information is used to request for authentication of the PIN element. In response to receiving the second request information, the second network function sends third request information to a third network function, where the third request information is used to request for obtaining auxiliary information of the credential. The third network function receives the third request information sent by the second network function. In response to determining that the PIN element gateway is a legal gateway, the auxiliary information is sent to the second network element; or, in response to determining that the PIN element gateway is an illegal gateway, the credential provisioning process is terminated.

In some embodiments, the auxiliary information includes at least one of the following:
a PIN element gateway identifier;
an authentication manner;
a fully qualified domain name (FQDN) of a provisioning server (PVS); or
address information of a provisioning server (PVS).

In some embodiments, whether the PIN element gateway is authorized as a legal gateway is checked according to subscription information of the PIN element gateway. In response to determining that the PIN element gateway is a legal gateway, the auxiliary information is sent to the second network function; or, in response to determining that the PIN element gateway is an illegal gateway, the credential provisioning process is terminated.

In some embodiments, in response to determining that the PIN element gateway is a legal gateway, an authentication manner for the PIN element is determined according to predetermined information. For the third request information, the auxiliary information is sent to the second network function.

In some embodiments, the predetermined information includes at least one of the following:
a PIN element gateway identifier;
subscription data of a PIN element gateway;
a credential provisioning indicator; or
a PIN element identifier.

It should be noted that those skilled in the art may understand that the method provided in the embodiments of the present disclosure may be performed separately, or may be performed together with some methods in the embodiments of the present disclosure or some methods in the related art.

FIG. 18 is a schematic flowchart of a method for personal IoT network (PIN) element credential provisioning shown according to some embodiments of the present disclosure. As shown in FIG. 18, the method for personal IoT network (PIN) element credential provisioning according to embodiments of the present disclosure is applied to a third second network function, and the method for personal IoT network (PIN) element credential provisioning includes the following processing steps.

In step 181, in response to determining that the PIN element gateway is a legal gateway, an authentication manner for the PIN element is determined according to predetermined information.

In some embodiments, the predetermined information includes at least one of the following:
a PIN element gateway identifier;
subscription data of a PIN element gateway;
a credential provisioning indicator; or
a PIN element identifier.

In some embodiments, whether the PIN element gateway is authorized as a legal gateway is checked according to subscription information of the PIN element gateway. In response to determining that the PIN element gateway is a legal gateway, the auxiliary information is sent to the second network function; or, in response to determining that the PIN element gateway is an illegal gateway, the credential provisioning process is terminated.

In some embodiments, in response to determining that the PIN element gateway is a legal gateway, an authentication manner for the PIN element is determined according to predetermined information. For the third request information, the auxiliary information is sent to the second network function.

It should be noted that those skilled in the art may understand that the method provided in the embodiments of the present disclosure may be performed separately, or may be performed together with some methods in the embodiments of the present disclosure or some methods in the related art.

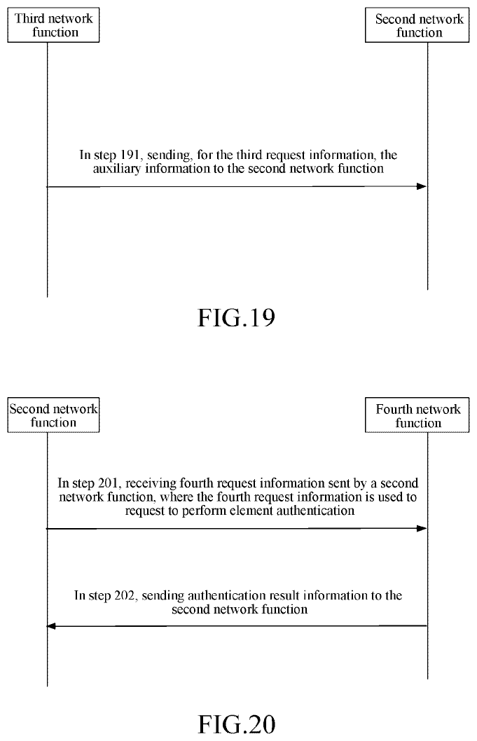

FIG. 19 is a schematic flowchart of a method for personal IoT network (PIN) element credential provisioning shown according to some embodiments of the present disclosure. As shown in FIG. 19, the method for personal IoT network (PIN) element credential provisioning according to embodiments of the present disclosure is applied to a third second network function, and the method for personal IoT network (PIN) element credential provisioning includes the following processing steps.

In step 191, for the third request information, the auxiliary information is sent to the second network function.

In some embodiments, whether the PIN element gateway is authorized as a legal gateway is checked according to subscription information of the PIN element gateway. In response to determining that the PIN element gateway is a legal gateway, the auxiliary information is sent to the second network function; or, in response to determining that the PIN element gateway is an illegal gateway, the credential provisioning process is terminated.

In some embodiments, in response to determining that the PIN element gateway is a legal gateway, an authentication manner for the PIN element is determined according to predetermined information. For the third request information, the auxiliary information is sent to the second network function.

In some embodiments, the predetermined information includes at least one of the following:
a PIN element gateway identifier;
subscription data of a PIN element gateway;
a credential provisioning indicator; or
a PIN element identifier.

It should be noted that those skilled in the art may understand that the method provided in the embodiments of the present disclosure may be performed separately, or may be performed together with some methods in the embodiments of the present disclosure or some methods in the related art.

FIG. 20 is a schematic flowchart of a method for personal IoT network (PIN) element credential provisioning shown according to some embodiments of the present disclosure. As shown in FIG. 20, the method for personal IoT network (PIN) element credential provisioning according to embodiments of the present disclosure is applied to a fourth second network function, and the method for personal IoT network (PIN) element credential provisioning includes the following processing steps.

In step 201, fourth request information sent by a second network function is received, where the fourth request information is used to request for performing element authentication.

In step 202, authentication result information is sent to the second network function.

The second network function may include an authentication server function (AUSF). Those skilled in the art should understand that, when another network function of the core network implements the function of the AUSF, another network function of the core network may also be enabled as the second network function. Alternatively, when another network function of the core network is configured with the corresponding function of the second network function in the embodiments of the present disclosure, another network function of the core network may also be enabled as the second network function.

The fourth network function may include a network slice-specific authentication and authorization function (NSSAAF). Those skilled in the art should understand that, when another network function of the core network implements the function of the NSSAAF, another network function of the core network may also be enabled as the fourth network function. Alternatively, when another network function of the core network is configured with the corresponding function of the fourth network function in the embodiments of the present disclosure, another network function of the core network may also be enabled as the fourth network function.

In some embodiments, fourth request information sent by a second network function is received, where the fourth request information is used to request for performing element authentication, and the fourth request information indicates an element identifier. A third-party authentication authorization accounting (AAA) server is determined. For example, the third-party AAA server may be determined based on the element identifier.

In some embodiments, information of the PIN element identifier is sent to the third-party AAA server. Mutual authentication is performed with the third-party AAA server based on an extensible authentication protocol (EAP) authentication mechanism and a predetermined credential. In response to successful authentication, the authentication result information sent by the third-party AAA server is received, and the authentication result information is sent to the second network function; or, in response to authentication failure, the credential provisioning process is terminated.

In some embodiments, for the fourth request information, the authentication result information is sent to the second network function. For example, in response to successful authentication, a message of successful EAP authentication is sent to the second network function.

It should be noted that those skilled in the art may understand that the method provided in the embodiments of the present disclosure may be performed separately, or may be performed together with some methods in the embodiments of the present disclosure or some methods in the related art.

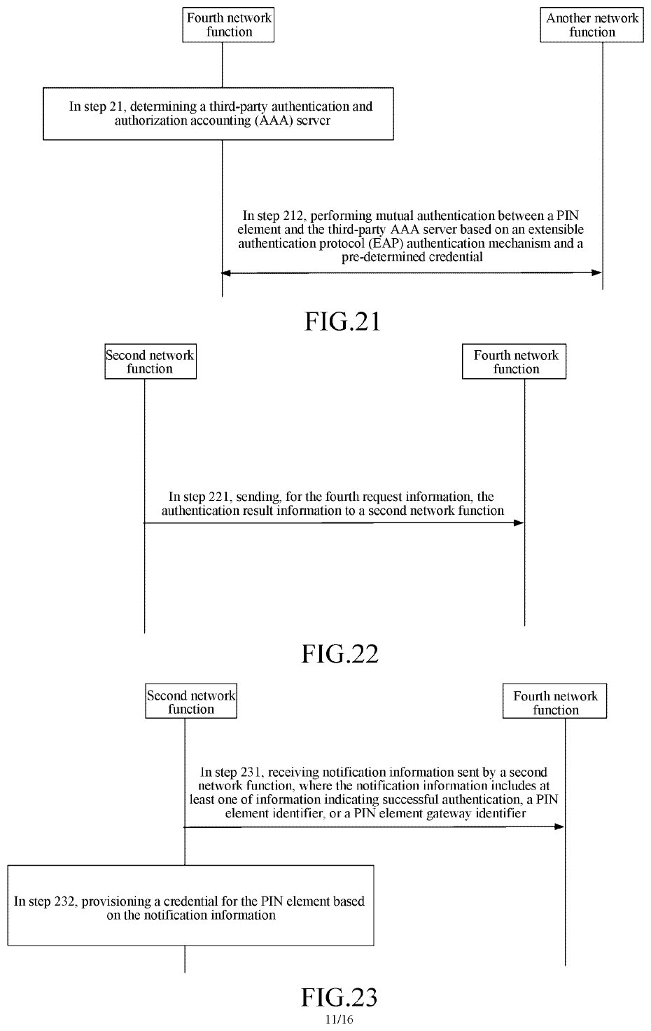

FIG. 21 is a schematic flowchart of a method for personal IoT network (PIN) element credential provisioning shown according to some embodiments of the present disclosure. As shown in FIG. 21, the method for personal IoT network (PIN) element credential provisioning according to embodiments of the present disclosure is applied to a fourth second network function, and the method for personal IoT network (PIN) element credential provisioning includes the following processing steps.

In step 211, a third-party authentication authorization accounting (AAA) server is determined.

In step 212, mutual authentication between a PIN element and the third-party AAA server is performed based on an extensible authentication protocol (EAP) authentication mechanism and a predetermined credential.

In some embodiments, fourth request information sent by a second network function is received, where the fourth request information is used to request for performing element authentication, and the fourth request information indicates an PIN element identifier. A third-party authentication authorization accounting (AAA) server is determined. For example, the third-party AAA server may be determined based on the PIN element identifier.

In some embodiments, information of the PIN element identifier is sent to the third-party AAA server. Mutual authentication is performed with the third-party AAA server based on an extensible authentication protocol (EAP) authentication mechanism and a predetermined credential. In response to successful authentication, the authentication result information sent by the third-party AAA server is received, and the authentication result information is sent to the second network function; or, in response to authentication failure, the credential provisioning process is terminated.

In some embodiments, for the fourth request information, the authentication result information is sent to the second network function. For example, in response to successful authentication, a message of successful EAP authentication is sent to the second network function.

It should be noted that those skilled in the art may understand that the method provided in the embodiments of the present disclosure may be performed separately, or may be performed together with some methods in the embodiments of the present disclosure or some methods in the related art.

FIG. 22 is a schematic flowchart of a method for personal IoT network (PIN) element credential provisioning shown according to some embodiments of the present disclosure. As shown in FIG. 22, the method for personal IoT network (PIN) element credential provisioning according to embodiments of the present disclosure is applied to a fourth second network function, and the method for personal IoT network (PIN) element credential provisioning includes the following processing steps.

In step 221, for the fourth request information, the authentication result information is sent to a second network function.

In some embodiments, information of the PIN element identifier is sent to the third-party AAA server. Mutual authentication between a PIN element and the third-party AAA server is performed based on an extensible authentication protocol (EAP) authentication mechanism and a predetermined credential. In response to successful authentication, the authentication result information sent by the third-party AAA server is received; or, in response to authentication failure, the credential provisioning process is terminated.

In some embodiments, for the fourth request information, the authentication result information is sent to the second network function. For example, in response to successful authentication, a message of successful EAP authentication is sent to the second network function.

In some embodiments, information of the PIN element identifier is sent to the third-party AAA server. Mutual authentication is performed with the third-party AAA server based on an extensible authentication protocol (EAP) authentication mechanism and a predetermined credential. In response to successful authentication, the authentication result information sent by the third-party AAA server is received, and the authentication result information is sent to the second network function; or, in response to authentication failure, the credential provisioning process is terminated.

It should be noted that those skilled in the art may understand that the method provided in the embodiments of the present disclosure may be performed separately, or may be performed together with some methods in the embodiments of the present disclosure or some methods in the related art.

FIG. 23 is a schematic flowchart of a method for personal IoT network (PIN) element credential provisioning shown according to some embodiments of the present disclosure. As shown in FIG. 23, the method for personal IoT network (PIN) element credential provisioning according to embodiments of the present disclosure is applied to an application function, and the method for personal IoT network (PIN) element credential provisioning includes the following processing steps.

In step 231, notification information sent by a second network function is received, where the notification information includes at least one of the following:
information indicating successful authentication;
a PIN element identifier; or
a PIN element gateway identifier.

In step 232, a credential is provisioned to the PIN element based on the notification information.

In some embodiments, the information indicating successful authentication indicates an effective time of the information indicating successful authentication.

It should be noted that the information indicating successful authentication includes a validity period. After the validity period is expired, the information indicating successful authentication is invalid. The PVS no longer recognizes that the PIN element authentication is successful, or no longer provisions a credential to the PIN element.

The second network function may include an authentication server function (AUSF). Those skilled in the art should understand that, when another network function of the core network implements the function of the AUSF, another network function of the core network may also be enabled as the second network function. Alternatively, when another network function of the core network is configured with the corresponding function of the second network function in the embodiments of the present disclosure, another network function of the core network may also be enabled as the second network function.

The application function may be a network function of an intranet, an AAA server of an intranet, or an application function of an intranet, such as a provisioning server (PVS). Those skilled in the art should understand that, when another network function of the core network implements the function of the PVS, another network function of the core network may also be enabled as the application function. Alternatively, when another network function of the core network is configured with the corresponding function of the application function in the embodiments of the present disclosure, another network function of the core network may also be enabled as the application function.

In some embodiments, notification information sent by the second network function is received, where the notification information includes at least one of information indicating successful authentication, a PIN element identifier, or a PIN element gateway identifier. It is determined, based on the notification information, whether authentication of the PIN element is successful. In response to successful authentication of the PIN element, a credential provisioning request sent by the PIN element is accepted, and a credential is provisioned to the PIN element. For example, in response to receiving fifth request information sent by the PIN element, an operator credential is provisioned to the PIN element, where the fifth request information is used to request for the operator credential.

It should be noted that those skilled in the art may understand that the method provided in the embodiments of the present disclosure may be performed separately, or may be performed together with some methods in the embodiments of the present disclosure or some methods in the related art.

In order to better understand the technical solutions of the present disclosure, the technical solutions of the present disclosure are further described below by using two embodiments.

Example 1: the following should be noted.
1. It is assumed that a secure non-3GPP connection with the PEGC has been established by the PIN element, which exceeds the scope of 3GPP.
2. The PIN element is preconfigured with a default credential that is generated by a third-party AAA server. The third-party AAA server maintains a mapping between the device identifier and the default credential for each PIN element.
3. The PEGC has been registered to the 5G system. The connection between the PEGC and the AMF is protected by the security of the NAS.

The following is a process of a solution based on a user plane, which is used for securely provisioning an operator credential to a personal IoT network equipped with a third-party AAA.

In some embodiments, the PEGC corresponds to the UE; the first network element corresponds to the AMF or the SEAF; the second network element corresponds to the AUSF; the third network element corresponds to the UDM; the fourth network element corresponds to the NSSAAF; and the fifth network element corresponds to the PVS.

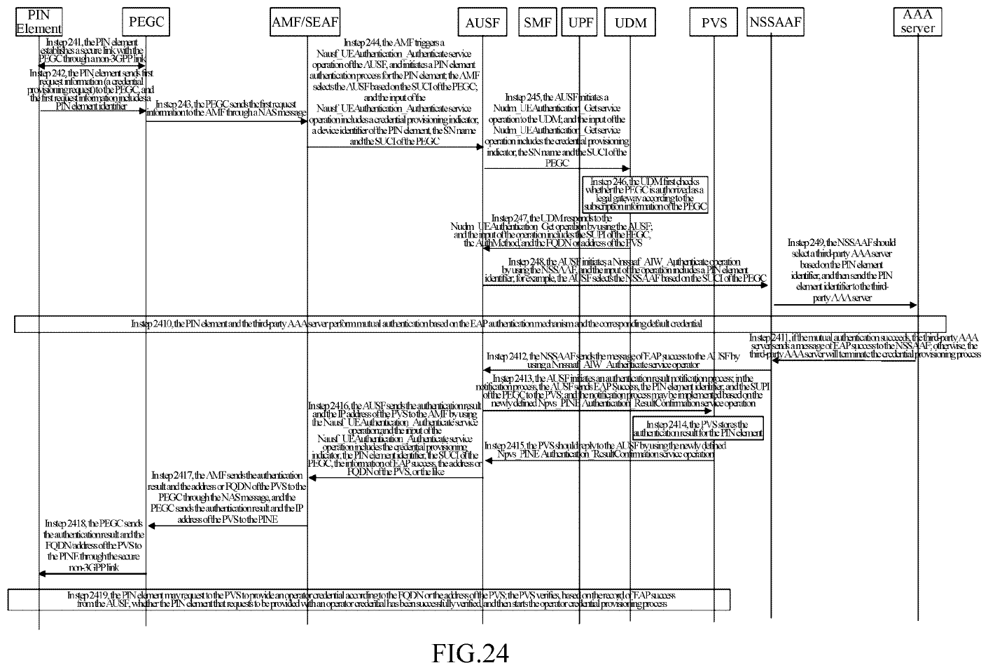

Referring to FIG. 24, there is provided a method for personal IoT network device credential provisioning, and the method includes following steps.

In step 241, the PIN element establishes a secure connection with the PEGC through a non-3GPP connection.

In step 242, the PIN element sends first request information (a credential provisioning request) to the PEGC, where the first request information includes a PIN element identifier.

In step 243, the PEGC sends sixth request information to the AMF through a NAS message. The sixth request information includes a credential provisioning indicator, a PIN element identifier, and an SUCI of the PEGC. The credential provisioning indicator indicates the purpose of this request.

In step 244, the AMF triggers a Nausf_UEAuthentication_Authenticate service operation of the AUSF, and initiates a PIN element authentication process for the PIN element; the AMF selects the AUSF based on the SUCI of the PEGC; and the input of the Nausf_UEAuthentication_Authenticate service operation includes a credential provisioning indicator, a device identifier of the PIN element, the SN name and the SUCI of the PEGC.

In step 245, the AUSF initiates a Nudm_UEAuthentication_Get service operation to the UDM; and the input of the Nudm_UEAuthentication_Get service operation includes the credential provisioning indicator, the SN name and the SUCI of the PEGC.

In step 246, the UDM first checks whether the PEGC is authorized as a legal gateway according to the subscription information of the PEGC; if the PEGC is not authorized as a gateway, the UDM will terminate the credential provisioning process; otherwise, the UDM determines the credential provisioning method for the PIN element based on the SUPI of the PGEC, the subscription data of the PEGC, and the credential provisioning indicator.

In step 247, the UDM responds to the Nudm_UEAuthentication_Get operation by using the AUSF; and the input of the operation includes the SUPI of the PEGC, the AuthMethod, and the FQDN or address of the PVS.

In step 248, the AUSF initiates a Nnssaaf_AIW_Authenticate operation by using the NSSAAF, and the input of the operation includes a PIN element identifier. For example, the AUSF selects the NSSAAF based on the SUCI of the PEGC.

In step 249, the NSSAAF should select a third-party AAA server based on the PIN element identifier, and then send the PIN element identifier to the third-party AAA server.

In step 2410, the PIN element and the third-party AAA server perform mutual authentication based on the EAP authentication mechanism and the corresponding default credential.

In step 2411, if the mutual authentication succeeds, the third-party AAA server sends a message of EAP success to the NSSAAF; otherwise, the third-party AAA server will terminate the credential provisioning process.

In step 2412, the NSSAAF sends the message of EAP success to the AUSF by using a Nnssaaf_AIW_Authenticate service operator.

In step 2413, the AUSF initiates an authentication result notification process. In the notification process, the AUSF sends EAP Success, the PIN element identifier, and the SUPI of the PEGC to the PVS. The notification process may be implemented based on the newly defined Npvs_PINE Authentication_ResultConfirmation service operation.

In step 2414, the PVS stores the authentication result for the PIN element.

In step 2415, the PVS should reply to the AUSF by using the newly defined Npvs_PINE Authentication_ResultConfirmation service operation.

In step 2416, the AUSF sends the authentication result and the IP address of the PVS to the AMF by using the Nausf_UEAuthentication_Authenticate service operation. The input of the Nausf_UEAuthentication_Authenticate service operation includes the credential provisioning indicator, the PIN element identifier, the SUCI of the PEGC, the information of EAP success, the address or FQDN of the PVS, or the like.

In step 2417, the AMF sends the authentication result and the address or FQDN of the PVS to the PEGC through the NAS message. The PEGC sends the authentication result and the IP address of the PVS to the PINE (corresponding to PIN element).

In step 2418, the PEGC sends the authentication result and the FQDN/address of the PVS to the PINE through the secure non-3GPP connection.

In step 2419, the PIN element may request to the PVS for provisioning an operator credential according to the FQDN or the address of the PVS. The PVS verifies, based on the record of EAP success from the AUSF, whether the PIN element that requests for being provisioned with an operator credential has been successfully verified, and then starts the operator credential provisioning process.

Example 2: the following should be noted.
1. It is assumed that a secure non-3GPP connection with the PEGC has been established by the PIN element, which exceeds the scope of 3GPP.
2. The PIN element is preconfigured with a default credential that is generated by a third-party AAA server. The third-party AAA server maintains a mapping between the device identifier and the default credential for each PIN element.
3. The PEGC has been registered to the 5G system. The connection between the PEGC and the AMF is protected by the security of the NAS.

The following is a process of a solution based on a user plane, which is used for securely provisioning an operator credential to a personal IoT network equipped with a third-party AAA.

In some embodiments, the PEGC corresponds to the UE; the first network element corresponds to the AMF or the SEAF; the second network element corresponds to the AUSF; the third network element corresponds to the UDM; the fourth network element corresponds to the NSSAAF; and the fifth network element corresponds to the PVS.

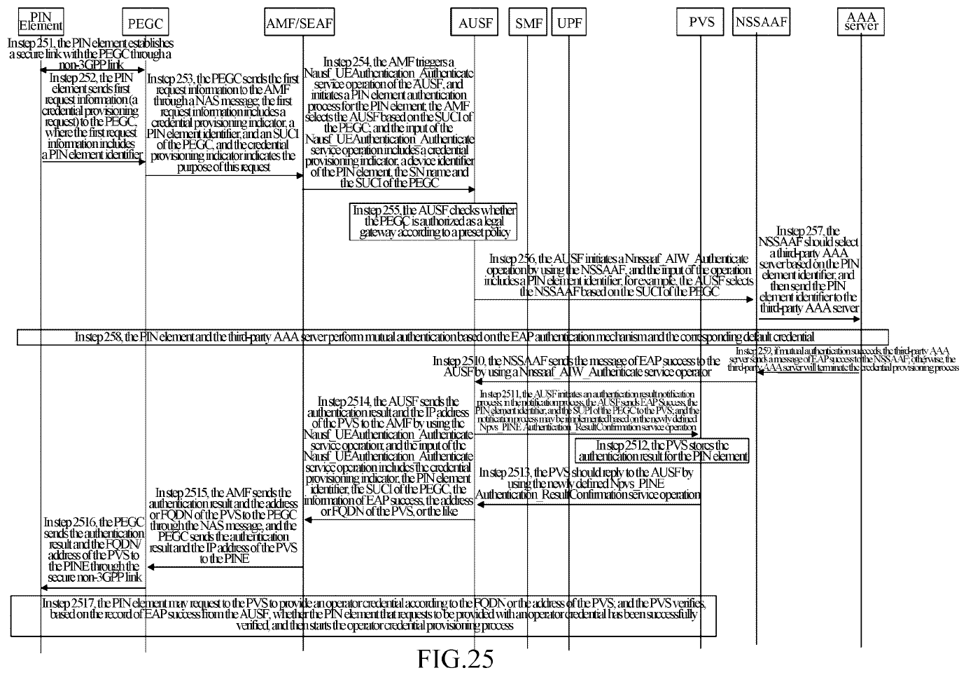

Referring to FIG. 25, there is provided a method for personal IoT network device credential provisioning, and the method includes following steps.

In step 251, the PIN element establishes a secure connection with the PEGC through a non-3GPP connection.

In step 252, the PIN element sends first request information (a credential provisioning request) to the PEGC, where the first request information includes a PIN element identifier.

In step 253, the PEGC sends sixth request information to the AMF through a NAS message. The sixth request information includes a credential provisioning indicator, a PIN element identifier, and an SUCI of the PEGC. The credential provisioning indicator indicates the purpose of this request.

In step 254, the AMF triggers a Nausf_UEAuthentication_Authenticate service operation of the AUSF, and initiates a PIN element authentication process for the PIN element; the AMF selects the AUSF based on the SUCI of the PEGC; and the input of the Nausf_UEAuthentication_Authenticate service operation includes a credential provisioning indicator, a device identifier of the PIN element, the SN name and the SUCI of the PEGC.

In step 255, the AUSF checks whether the PEGC is authorized as a legal gateway according to a preset policy.

In step 256, the AUSF initiates a Nnssaaf_AIW_Authenticate operation by using the NSSAAF, and the input of the operation includes a PIN element identifier. For example, the AUSF selects the NSSAAF based on the SUCI of the PEGC.

In step 257, the NSSAAF should select a third-party AAA server based on the PIN element identifier, and then send the PIN element identifier to the third-party AAA server.

In step 258, the PIN element and the third-party AAA server perform mutual authentication based on the EAP authentication mechanism and the corresponding default credential.

In step 259, if mutual authentication succeeds, the third-party AAA server sends a message of EAP success to the NSSAAF; otherwise, the third-party AAA server will terminate the credential provisioning process.

In step 2510, the NSSAAF sends the message of EAP success to the AUSF by using a Nnssaaf_AIW_Authenticate service operator.

In step 2511, the AUSF initiates an authentication result notification process. In the notification process, the AUSF sends EAP Success, the PIN element identifier, and the SUPI of the PEGC to the PVS. The notification process may be implemented based on the newly defined Npvs_PINE Authentication_ResultConfirmation service operation.

In step 2512, the PVS stores the authentication result for the PIN element.

In step 2513, the PVS should reply to the AUSF by using the newly defined Npvs_PINE Authentication_ResultConfirmation service operation.

In step 2514, the AUSF sends the authentication result and the IP address of the PVS to the AMF by using the Nausf_UEAuthentication_Authenticate service operation. The input of the Nausf_UEAuthentication_Authenticate service operation includes the credential provisioning indicator, the PIN element identifier, the SUCI of the PEGC, the information of EAP success, the address or FQDN of the PVS, or the like.

In step 2515, the AMF sends the authentication result and the address or FQDN of the PVS to the PEGC through the NAS message. The PEGC sends the authentication result and the IP address of the PVS to the PINE.

In step 2516, the PEGC sends the authentication result and the FQDN/address of the PVS to the PINE through the secure non-3GPP connection.

In step 2517, the PIN element may request to the PVS for provisioning an operator credential according to the FQDN or the address of the PVS. The PVS verifies, based on the record of EAP success from the AUSF, whether the PIN element that requests for being provisioned with an operator credential has been successfully verified, and then starts the operator credential provisioning process.

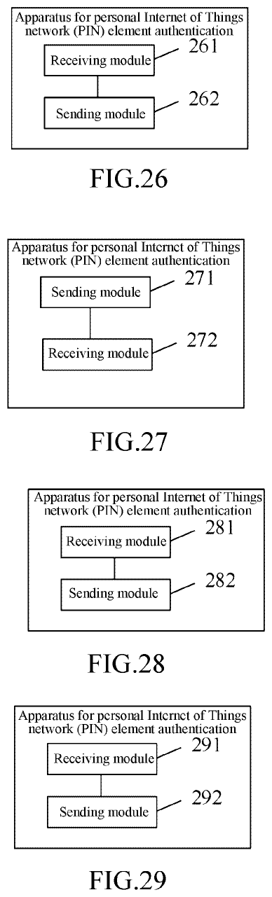

As shown in FIG. 26, there is provided an apparatus for personal IoT network (PIN) element authentication according to the embodiment, where the apparatus includes a receiving module 261 and a sending module 262.

The receiving module 261 is configured to receive first request information sent by a PIN element, where the first request information is used to request for provisioning a credential to the PIN element.

The sending module 262 is configured to send the authentication result information to the PIN element after the PIN element gateway performs the operation of credential provisioning.

It should be noted that those skilled in the art may understand that the method provided in the embodiments of the present disclosure may be performed separately, or may be performed together with some methods in the embodiments of the present disclosure or some methods in the related art.

As shown in FIG. 27, there is provided an apparatus for personal IoT network (PIN) element authentication according to the embodiment, where the apparatus includes a sending module 271 and a receiving module 272.

The sending module 271 is configured to send first request information to a PIN element gateway, where the first request information is used to request for provisioning a credential to a PIN element.

The receiving module 272 is configured to receive authentication result information sent by the PIN element gateway.

It should be noted that those skilled in the art may understand that the method provided in the embodiments of the present disclosure may be performed separately, or may be performed together with some methods in the embodiments of the present disclosure or some methods in the related art.

As shown in FIG. 28, there is provided an apparatus for personal IoT network (PIN) element authentication according to the embodiment, where the apparatus includes a receiving module 281 and a sending module 282.

The receiving module 281 is configured to receive sixth request information sent by a PIN element gateway, where the sixth request information is used to request for provisioning a credential to a PIN element.

The sending module 282 is configured to send authentication result information to the PIN element gateway after the first network function performs an operation of credential provisioning.

It should be noted that those skilled in the art may understand that the method provided in the embodiments of the present disclosure may be performed separately, or may be performed together with some methods in the embodiments of the present disclosure or some methods in the related art.

As shown in FIG. 29, there is provided an apparatus for personal IoT network (PIN) element authentication according to the embodiment, where the apparatus includes a receiving module 291 and a sending module 292.

The receiving module 291 is configured to receive second request information sent by a first network function, where the second request information is used to request for authentication of a PIN element.

The sending module 292 is configured to send authentication result information to the first network function after the second network function performs authentication of the PIN element.

It should be noted that those skilled in the art may understand that the method provided in the embodiments of the present disclosure may be performed separately, or may be performed together with some methods in the embodiments of the present disclosure or some methods in the related art.

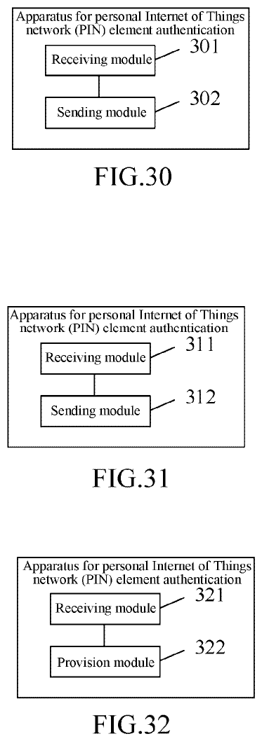

As shown in FIG. 30, there is provided an apparatus for personal IoT network (PIN) element authentication according to the embodiment, where the apparatus includes a receiving module 301 and a sending module 302.

The receiving module 301 is configured to receive third request information sent by a second network function, where the third request information is used to request for obtaining auxiliary information of a credential.

The sending module 302 is configured to send the auxiliary information to the second network function.

It should be noted that those skilled in the art may understand that the method provided in the embodiments of the present disclosure may be performed separately, or may be performed together with some methods in the embodiments of the present disclosure or some methods in the related art.

As shown in FIG. 31, there is provided an apparatus for personal IoT network (PIN) element authentication according to the embodiment, where the apparatus includes a receiving module 311 and a sending module 312.

The receiving module 311 is configured to receive fourth request information sent by a second network function, where the fourth request information is used to request for performing element authentication.

The sending module 312 is configured to send the auxiliary information to the second network function.

It should be noted that those skilled in the art may understand that the method provided in the embodiments of the present disclosure may be performed separately, or may be performed together with some methods in the embodiments of the present disclosure or some methods in the related art.

As shown in FIG. 32, there is provided an apparatus for personal IoT network (PIN) element authentication according to the embodiment, where the apparatus includes a receiving module 321 and a provision module 322.

The receiving module 321 is configured to receive notification information sent by a second network function, where the notification information includes at least one of the following: information indicating successful authentication;
a PIN element identifier; or
a PIN element gateway identifier;
the provision module 322 is configured to provision a credential to the PIN element based on the notification information.

It should be noted that those skilled in the art may understand that the method provided in the embodiments of the present disclosure may be performed separately, or may be performed together with some methods in the embodiments of the present disclosure or some methods in the related art.

According to embodiments of the present disclosure, there is provided a communication device, and the communication device includes:
a processor; and
a memory, configured for storing an executable instruction by the processor;
where the processor is configured to, when running the executable instruction, implement the method applied to any embodiment of the present disclosure.

In some embodiments, the processor may include various types of storage medium. The storage medium is a non-transitory computer storage medium, and after the communication device is powered down, the storage medium can continue to memorize the information stored thereon.

The processor may be connected to the memory by using a bus or the like, and is configured to read the executable program stored in the memory.

According to embodiments of the present disclosure, there is further provided a computer storage medium, where the computer storage medium stores a computer-executable program, and when the executable program is executed by a processor, the method according to any embodiment of the present disclosure is implemented.

With regard to the apparatus in the above embodiments, the specific manner for the various modules to perform operations has been described in detail in the embodiments related to the method, which will not be described in detail here.

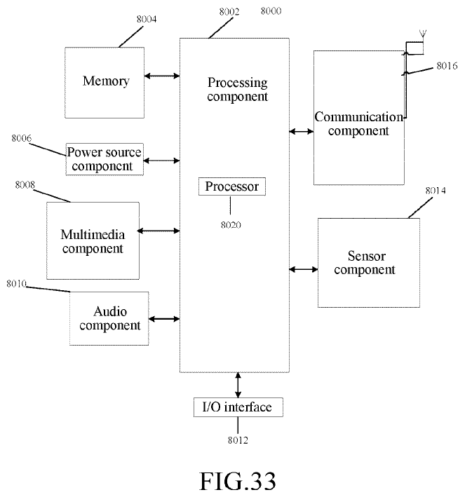

FIG. 33 is a block diagram of user equipment 8000 shown according to some embodiments of the present disclosure. For example, the user equipment 8000 may be a mobile phone, a computer, a digital broadcast user device, a message transceiving device, a game console, a tablet device, a medical device, a fitness device, a personal digital assistant, or the like.

Referring to FIG. 33, the user equipment 8000 may include one or more of the following components: a processing component 8002, a memory 8004, a power source component 8006, a multimedia component 8008, an audio component 8010, an input/output (I/O) interface 8012, a sensor component 8014, and a communication component 8016.

The processing component 8002 generally controls overall operations of the user equipment 8000, such as operations associated with display, telephone calls, data communications, camera operations, and recording operations. The processing component 8002 may include one or more processors 8020 to execute instructions to complete all or part of the steps of the above-mentioned method for personal IoT network device credential provisioning. In addition, the processing component 8002 may include one or more modules to facilitate interaction between the processing component 8002 and other components. For example, the processing component 8002 may include a multimedia module to facilitate the interaction between the multimedia component 8008 and the processing component 8002.

The memory 8004 is configured to store various types of data to support the operation of the user equipment 8000. Examples of such data include instructions of any application or method operating on the user equipment 8000, contact data, phonebook data, messages, pictures, videos, etc. The memory 8004 may be implemented by any type of volatile or non-volatile storage device or a combination of them, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power source component 8006 provides power to various components of the user equipment 8000. The power source component 8006 may include a power management system, one or more power sources, and other components associated with the generation, management, and distribution of power for the user equipment 8000.

The multimedia component 8008 includes a screen providing an output interface between the user equipment 8000 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touching, sliding, and gestures on the touch panel. The touch sensor may not only sense a boundary of a touching or sliding action, but also sense a duration and pressure associated with a touching or sliding action. In some embodiments, the multimedia component 8008 includes a front camera and/or a rear camera. The front camera and/or the rear camera may receive external multimedia data when the user equipment 8000 is in an operation mode, such as a photographing mode or a video mode. Each of the front camera and the rear camera may be a fixed optical lens system or have focal length and optical zoom capability.

The audio component 8010 is configured to output and/or input an audio signal. For example, the audio component 8010 includes a microphone (MIC) configured to receive an external audio signal when the user equipment 8000 is in an operation mode, such as a call mode, a recording mode, and a speech recognition mode. The received audio signal may be further stored in the memory 8004 or transmitted via the communication component 8016. In some embodiments, the audio component 8010 further includes a speaker for outputting an audio signal.

The I/O interface 8012 provides an interface between the processing component 802 and a peripheral interface module, and the peripheral interface module may be a keyboard, a click wheel, a button, or the like. The button may include, but is not limited to, a home button, a volume button, a starting button, or a locking button.

The sensor component 8014 includes one or more sensors to provide status assessments of various aspects of the user equipment 8000. For example, the sensor component 8014 may detect an on/off state of the user equipment 8000, relative positioning of the components, for example, the components are a display and a keypad of the user equipment 8000. The sensor component 8014 may further detect a position change of the user equipment 8000 or one component in the user equipment 8000, presence or absence of the contact between the user and the user equipment 8000, orientation or acceleration/deceleration of the user equipment 8000, and the temperature change of the user equipment 8000. The sensor component 8014 may include a proximity sensor configured to detect the presence of nearby objects without any physical contact. The sensor component 8014 may also include an optical sensor, such as a CMOS or CCD image sensor, for use in imaging applications. In some embodiments, the sensor component 8014 may further include an acceleration sensor, a gyroscope sensor, a magnetic sensor, a pressure sensor, or a temperature sensor.

The communication component 8016 is configured to facilitate wired or wireless communication between the user equipment 8000 and other devices. The user equipment 8000 may access a wireless network based on a communication standard, such as Wi-Fi, 2G, or 3G, or a combination of them. In some embodiments, the communication component 8016 receives a broadcast signal or broadcast-related information from an external broadcast management system via a broadcast channel. In some embodiments, the communication component 8016 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In some embodiments, the user equipment 8000 may be implemented by one or more application specific integrated circuits (ASICs), digital signal processor (DSPs), digital signal processing device (DSPDs), programmable logic device (PLDs), field programmable gate array (FPGAs), controllers, microcontrollers, microprocessors, or other electronic components, for performing the steps of the above-mentioned method for personal IoT network device credential provisioning.

In some embodiments, there is further provided a non-transitory computer-readable storage medium including an instruction, for example, the memory 8004 including an instruction. The instruction may be executed by the processor 8020 of the user equipment 8000 to complete the steps of the above-mentioned method for personal IoT network device credential provisioning. For example, the non-transitory computer-readable storage medium may be a ROM, a random access memory (RAM), a CD-ROM, a magnetic tape, a floppy disk, an optical data storage device, or the like.

In the technical solution of the embodiments of the present disclosure, first request information sent by a PIN element is received, where the first request information is used to request for provisioning a credential to the PIN element; and after a PIN element gateway performs an operation of credential provisioning, the authentication result information is sent to the PIN element. In a case that the PIN element accesses the PIN through the PIN element gateway, the network may perform authentication of the PIN element based on the first request information, and after successful authentication, the PIN element may obtain the credential and access the network securely. Compared with the mechanism that does not use an operator credential, identity authentication of the PIN element by the network is implemented, so that the network may participate in identification and management of the PIN element, thus improving the communication security of the PIN.

Other embodiments of the embodiments of the present disclosure will be apparent to those skilled in the art from consideration of the description and practice of the present disclosure here. The present disclosure is intended to cover any variations, uses, or adaptations of the embodiments of the present disclosure that follow the general principles of the embodiments of the present disclosure and include common general knowledge or conventional technical means in the art that are not disclosed in the embodiments of the present disclosure. It is intended that the description and examples may be considered as examples only, with a true scope and spirit of the embodiments of the present disclosure being indicated by the following claims.

It should be understood that the embodiments of the present disclosure are not limited to the precise structures that have been described above and shown in the accompanying drawings, and various modifications and changes may be made without departing from the scope of the present disclosure. The scope of the embodiments of the present disclosure is limited only by the appended claims.

1. A method for personal IoT network (PIN) element credential provisioning, wherein the method is performed by a PIN element gateway, and the method comprises:
receiving first information sent by a PIN element, wherein the first information is used to request for provisioning a credential to the PIN element; and
sending authentication result information to the PIN element in response to the PIN element gateway performing an operation of credential provisioning.

2. (canceled)

3. The method according to claim 1, wherein the operation of credential provisioning by the PIN element gateway comprises:
sending sixth information to a first network function;
wherein the first information indicates at least one of:
a credential provisioning indicator; or
a PIN element identifier.

4. The method according to claim 3, wherein sending the sixth information to the first network function comprises:
sending the sixth information to the first network function based on a protected manner;
wherein sending the sixth information to the first network function based on the protected manner comprises:
sending the sixth information to the first network function through a non-access stratum (NAS) message.

5. (canceled)

6. The method according to claim 3, wherein the operation of credential provisioning by the PIN element gateway comprises:
receiving the authentication result information sent by the first network function;
wherein the authentication result information comprises at least one of:
a credential provisioning indicator;
a PIN element identifier;
information indicating successful authentication;
a fully qualified domain name (FQDN) of a provisioning server (PVS);
address information of a provisioning server (PVS); or
a user plane credential provisioning indicator.

7. (canceled)

8. The method according to claim 6, wherein the information indicating successful authentication indicates an effective time of the information indicating successful authentication.

9. The method according to claim 6, wherein the method further comprises:
in response to the authentication result information indicating successful authentication, requesting for establishing a protocol data unit (PDU) session for operator credential provisioning.

10. The method according to claim 1, wherein sending the authentication result information to the PIN element comprises:
in response to the authentication result information indicating successful authentication, sending the authentication result information to the PIN element.

11. A method for personal IoT network (PIN) element credential provisioning, wherein the method is performed by a PIN element, and the method comprises:
sending first information to a PIN element gateway, wherein the first information is used to request for provisioning a credential to the PIN element; and
receiving authentication result information sent by the PIN element gateway.

12. The method according to claim 11, wherein the method further comprises:
establishing a secure connection between the PIN element and the PIN element gateway.

13. The method according to claim 11, wherein sending the first information to the PIN element gateway comprises:
sending the first information to the PIN element gateway based on the secure connection;
wherein the first information indicates at least one of:
a credential provisioning indicator; or
a PIN element identifier.
wherein the authentication result information comprises at least one of:
a credential provisioning indicator;
information indicating successful authentication;
a fully qualified domain name (FQDN) of a provisioning server (PVS);
address information of a provisioning server (PVS); or
a user plane credential provisioning indicator.

14.-15. (canceled)

16. The method according to claim 13, wherein the information indicating successful authentication indicates an effective time of the information indicating successful authentication.

17. The method according to claim 11, wherein the PIN element is preconfigured with at least one of a fully qualified domain name (FQDN) of a provisioning server (PVS), or address information of a PVS.

18.-68. (canceled)

69. A method for personal IoT network (PIN) element credential provisioning, comprising:
sending, by a PIN element, first information to a PIN element gateway, wherein the first information is used to request for provisioning a credential to the PIN element;
sending, by the PIN element gateway, sixth information to a first network function;
sending, by the first network function, second information to a second network function, wherein the second information is used to trigger authentication of the PIN element;
sending, by the second network function, third information to a third network function, wherein the third information is used to request for obtaining auxiliary information of a credential;
sending, by the third network function, the auxiliary information to the second network function;
sending, by the second network function, fourth information to a fourth network function, wherein the fourth information is used to request for performing authentication of the PIN element;
performing, by the fourth network function, mutual authentication between the PIN element and a third-party authentication authorization accounting (AAA) server;
receiving, by the fourth network function, authentication result information sent by the third-party AAA server, and sending the authentication result information to the second network function;
in response to the authentication result information indicating successful authentication, sending, by the second network function, notification information to an application function; and
provisioning, by the application function, a credential to the PIN element based on the notification information.

70. The method according to claim 69, wherein the method further comprises at least one of:
sending, by the second network function, the authentication result information to the first network function;
sending, by the first network function, the authentication result information to the PIN element gateway; or
sending, by the PIN element gateway, the authentication result information to the PIN element.

71. The method according to claim 69, wherein,
sending the sixth information to the first network function comprises sending the sixth information to the first network function through a non-access stratum (NAS) message;
performing mutual authentication between the PIN element and the third-party (AAA) server comprises performing mutual authentication between the PIN element and the third-party AAA server based on an extensible authentication protocol (EAP) authentication mechanism and a predetermined credential; and
provisioning the credential to the PIN element comprises in response to receiving fifth information sent by the PIN element, provisioning the credential to the PIN element; wherein the fifth information is used to request for the credential.

72. The method according to claim 69, wherein the method further comprises:
in response to successful authentication, terminating, by the fourth network function, a credential provisioning process;
wherein the sixth information indicates at least one of a credential provisioning indicator, a PIN element identifier, or a PIN element gateway identifier;
the second information comprises at least one of a credential provisioning indicator, a PIN element identifier, a PIN element gateway identifier, or a service network Identifier;
the auxiliary information comprises at least one of a PIN element gateway identifier, an authentication manner, a fully qualified domain name (FQDN) of a provisioning server (PVS), or address information of a provisioning server (PVS);
the fourth information indicates a PIN element identifier;
the authentication result information comprises at least one of a credential provisioning indicator, a PIN element identifier, a PIN element gateway identifier, information indicating successful authentication, a fully qualified domain name (FQDN) of a provisioning server (PVS), address information of a PVS, or a user plane credential provisioning indicator; wherein the information indicating successful authentication indicates an effective time of the information indicating successful authentication; and
the notification information comprises at least one of information indicating successful authentication, a PIN element identifier, or a PIN element gateway identifier.

73. The method according to claim 72, wherein the method further comprises at least one of:
selecting, by the second network function, the fourth network function based on the PIN element gateway identifier;
checking, by the third network function according to a policy, whether the PIN element gateway is authorized as a legal gateway of a PIN element corresponding to the PIN element identifier; or
selecting, by the fourth network function, the third-party AAA server based on the PIN element identifier.

74. The method according to claim 73, wherein sending the auxiliary information to the second network function comprises:
in response to determining that the PIN element gateway is an illegal gateway, terminating, by the third network function, a credential provisioning process; or
in response to determining that the PIN element gateway is a legal gateway, sending, by the third network function, the auxiliary information to the second network function, and determining an authentication manner for the PIN element according to predetermined information, wherein the predetermined information comprises at least one of a PIN element gateway identifier, subscription data of a PIN element gateway, a credential provisioning indicator, or a PIN element identifier.

75. A communication device, comprising:
a memory; and
a processor, connected to the memory, and configured to implement the method according to any one of claim 69.

76. A non-transitory computer storage medium, wherein a computer-executable instruction is stored in the computer storage medium, and after the computer-executable instruction is executed by a processor, the method according to claim 69 is implemented.
